(19) United States
(12) Patent Application Publication
(10) Pub. No.: US 2022/0147830 A1
(43) Pub. Date: May 12, 2022

(54) TRANSITION TABLE NETWORKS

(71) Applicants: DANA DOMINIAK, LEMONT, IL (US); HAROLD LEE PETERSON, PRESCOTT, AZ (US)

(72) Inventors: DANA DOMINIAK, LEMONT, IL (US); HAROLD LEE PETERSON, PRESCOTT, AZ (US)

(21) Appl. No.: 17/507,773

(22) Filed: Oct. 21, 2021

Related U.S. Application Data
(63) Continuation-in-part of application No. 63/104,055, filed on Oct. 22, 2020.

(51) Int. Cl. G06N 3/08

(52) U.S. Cl. CPC G06N 3/086

(57) ABSTRACT

A system and method for implementing and training network-based artificial intelligence functions is provided, wherein the signals within an artificial neural network are encoded as strings of symbols such as alphanumeric characters, rather than as numerical weighting values, and accordingly propagated by table functions rather than by summation or sigmoid functions used to handle weighting values. Further, a method is provided for training networks through an evolutionary winnowing and cross-hybridizing process. This different approach to artificial networking is inspired by the biology of genetics, combined with that of neurons, and is anticipated to improve the efficiency and nuance of AI modeling.

### CO-PENDING PATENT APPLICATION

This Nonprovisional patent application is a Continuation-in-Part patent application to Provisional Patent Application Ser. No. 63/104,055 as filed on Oct. 22, 2020, by Inventors Ms. Dana Dominiak and Mr. Harold Lee Peterson of the instant Nonprovisional patent application. Provisional Patent Application Ser. No. 63/104,055 is hereby incorporated in its entirety and for all purposes into the present disclosure.

### FIELD OF THE INVENTION

The present invention relates generally to artificial neural networks, and specifically to a networking structure modeled primarily after the biology of genetic propagation and secondarily after that of analog (a string of values) neural activity.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The field of artificial intelligence, machine learning, and neural networking is growing fast, as more applications for the technology are discovered and implementation of neural net models improves with practice. Already, artificial neural nets are used for applications such as speech recognition, image analysis, and adaptive control for artificial intelligence, allowing our computers to do more than ever before.

Traditional Neural Networks (NN) consist of a fully or partially connected structure of nodes. Each node contains a function, such as a ‘summation function’ or ‘sigmoidal function’, which can be represented by a mathematical equation. There are one or more inputs to each node. The inputs are ‘summed’ (or some other, such as a sigmoidal function is generated) at each node, and if an output threshold is reached, a numerical value is presented at the output. In turn, this output is linked to the input of yet another node, and so on to the final output of the network. An artificial neuron is inspired from actual neurons in nature.

While the field of conventional artificial neural networking has provided a lot of useful applications so far, synapses are a fairly simple and rudimentary model to follow, as biological networks go. Modeling an artificial network to mimic other, higher-order biological means of networking and signal propagation could easily produce more sophisticated artificial neural networking and advance the field of machine learning. While the limitations of the simplistic neuron model are becoming apparent as these are reached, there is a lot more available to be discovered and developed through the potential of neural networking. Further, the AI industry is hitting limits in processing capacity and capabilities of this traditional approach, which hardware upgrading can only mitigate so much.

Therefore, there is a long-felt need in the field of neural networking for further development and innovation that goes beyond the neuron-based network model.

### SUMMARY OF THE INVENTION

Towards these and other objects of the method of the present invention (hereinafter, “the invented method”) that are made obvious to one of ordinary skill in the art in light of the present disclosure, what is provided is a method for constructing and applying a neural network that transmits signals in the form of sets of symbols, such as alphanumeric character strings, rather than or in addition to numerical weighting.

This new machine learning technique utilizes the flow of alpha-numeric characters between nodes of a network (or graph database). Unlike a traditional neural network in which numeric values are transmitted between nodes, the invented Transition Table Networks (TTN) instead utilizes strings of characters or symbols.

A fully or partially connected network of nodes in a TTN exchanges strings of characters, instead of single values, on output nodes. Instead of a summation function, or other mathematical functions inside each node, TTNs use an alpha-numeric ‘transition table’ that determines each node's output string. As input strings move through the network, these are transitioned into new strings as dictated by the various transition tables at each node. The resulting output, while deterministic, may be very complex and nuanced, depending on the size of the network and the complexity of the transition tables.

A traditional neural network passes numerical values on links that connect nodes of a network. By contrast, TTNs pass alpha numeric strings between nodes. These strings allow for a more compact and abstract encoding of data than single numeric values. Therefore, TTNs allow for faster, more compact and memory efficient encoding of data.

A traditional neural network takes numerical values as inputs, performs a mathematical summation (or other, such as sigmoidal) function at each node, and presents a numerical output if the summation function passes a certain threshold. By contrast, TTNs do not work on numerical values, but instead pass strings of alpha-numeric characters, or ‘resources’, between network nodes.

The output of any given node is computed using transition tables, which dictate how any input is transformed into an output. The transition tables replace the mathematical functions of traditional NNs that are associated with each node. In addition, each transition table may have a secondary ‘shadow table’ that performs some alternative functionality as string values are transmitted through the network.

As a possible way to further understand the concepts of the invention, one should consider the ways in which the field of neural networking mimics biology. The domain of computational logic behind artificial neural networks, threshold logic, is based on scientific theory and observation developed by observing neurons in the human brain and nervous system, and building a mathematical model to codify what these were doing. Some of the methodology of the present invention is based, not on the nervous system like much of the prior art, but on DNA, the process of evolution, and evolutionary developmental biology. The entire genetic code for an organism is stored and transmitted as a series of symbols, namely the nucleotides cytosine, guanine, adenine, and thymine, codifying and signaling various messages through proteins for building and maintaining the organism, and which are passed on to the organism's offspring in regulated but random combinations produced through meiosis. In biological evolution, an organism having one or more traits, such as coloration, instinctive behavior, or physical features, that help this organism cope better than other organisms of the same kind in the environment and circumstances of this group of organisms' lives is more likely to survive, thrive, and reproduce, thus making the genotype of the successful organism more likely to be propagated to the next generation of that population of organisms. As the less-successful organisms are more likely to die sooner without having reproduced as much or at all, or to be less healthy or secure and therefore less able to attract a mate or support a pregnancy, the next generation is likely to contain more organisms with the successful organism's traits, and fewer organisms without, until eventually the most successful traits are included in most or all of the population. Similarly, a neural network can be trained in pattern recognition by postulating of an ‘environment’ where preferred symbols or groupings of symbols are likely to be more successful.

Using the invented transition table networking methods and techniques, a new type of general AI problem, which typically involves classification and comparison, can be accomplished using less processing power, less time, and less memory. The applications of the invented technology may include particular benefits to inter-asset decision making and coordination, that is improvement of artificial intelligence learning and simulation software and in situations where decisions need to be made both quickly and with limited input, such as for instance piloting of self-driving vehicles such as self-driving cars, planes, helicopters, drones, boats, lawnmowers, and robots that move around. Additional useful applications may include drone swarms and drone-to-drone communication; monitoring and controlling pumping systems (such as pipelines for water or oil, blood transfusion, or medicine dosing) and using feedback loops to better avoid pumps working against each other; monitoring, controlling, and load-balancing a power grid; predicting stocks, cryptocurrencies, weather, and non-linear and chaotic functions such as population growth/retraction over time; monitoring and controlling HVAC systems, large industrial ovens, blood sugar, insulin levels, and using bio-feedback monitors to automatically dispense medication; providing real-time language translation; noise correction and acoustic correction in audio systems; automated lighting adjustment in newsrooms, theaters, and movie or television sets; automated design and optimization of electrical circuits; fraud prevention in virtual and encrypted transactions; and summarization of documents or recorded messages. More exciting applications for this advancement are sure to follow availability of the technology, but among these is likely to be unprecedented leaps forward in sophisticated emulation of consciousness using artificial intelligence.

Further, this invented method, an optimized superstructure for AI, may advance the art of AI through providing the benefits of better compression and a more compact, nuanced, and efficient method of encoding network data. Transition table networks require no arbitrary weighting, back propagation, or other artificial adjustments of results that limit conventional neural nets, as all of these ‘details’ are accounted for in the strings of symbols. This technology is anticipated to offer a solution to scalability problems and provide more efficient and accurate AI training, reducing the processing, hardware, and memory requirements for producing functional or high-performing AI.

The present invention may include or provide at least a method for generating representations of neural networks comprising generating and applying a neural network model that transmits signals in the form of characters of individually distinguishable symbols of a set of symbols. This set of symbols may further comprise at least one symbol expressed as at least one alphanumeric character. The neural network model may be adapted to transmit alphanumeric character strings as internal signals carrying information.

Further, the present invention may include or provide an information technology system comprising at least one computer having a processor coupled with a memory and adapted to enable a database management software, a source database and a target database, and the memory enabled to access and apply instructions that operatively direct the information technology system to generate and apply a neural network model that transmits signals in the form of characters of individually distinguishable symbols of a set of symbols comprising at least three symbols.

It is noted that a transition table, much like a function table or a switch statement in computer code, may have a catch-all default case for any input that doesn't otherwise correspond to a table entry. This may be beneficial for many of the same reasons, such as to catch unexpected input which may otherwise produce undefined behavior. It is referred to in this document as the ‘default’ value.

Certain still alternate preferred embodiments of the invented method include one or more the elements or aspects of (a.) providing a plurality of nodes and edges, each edge connecting two nodes; (b.) altering an output symbol string of a node; (c.) programming a first selected node to perform a node operation upon a received input symbol string; (d.) associating a first transition table with the first selected node, the first transition table including a plurality of pairs of string segments and string operations (hereinafter, “plurality of pairs”); (e.) reception of a first input symbol string, wherein the first input symbol string includes at least one non-numeric symbol; (f.) comparing a first string segment of the first transition table with the first input symbol string; (g.) When a match between the first string element of the first transition table and a portion or all of the first input symbol string is detected, selecting a first string operation that is paired with the first string element within the plurality of pairs; (h.) deriving a resultant output string at least partially on the basis of an application of the first string operation in response to matching the at least one string element to a portion or all of the first input symbol string; and (i.) communicating the resultant output string from the first selected node to a second node of the graph database.

Certain still additional alternate preferred embodiments of the invented method include one or more the elements or aspects (a.) accepting at least a portion of an input symbol string as an operand and applying a mathematical/string matching operation to the selected operand and therefrom generating a result, whereby the resultant output string is at least partially derived from the result; (b.) applying a mathematical operation to the selected portion or all of an input symbol string and therefrom generating a result, whereby the resultant output string includes the result; (c.) replacing a selection or all of the first input symbol string with a first alternate symbol string in a generation of the resultant output string, whereby the first alternate symbol string is included in the resultant output string; (d.) generating a concatenated symbol string by concatenating a selection or all of the first input symbol string with a second alternate symbol string in a generation of the resultant output string, whereby the concatenated symbol string is included in the resultant output string; (e.) wherein the node operation generates a resultant output string that comprises the first input symbol string; (f.) wherein the node operation is not applied in deriving the resultant output string when a match is found between the first input symbol string and the first string segment; (g.) wherein the node operation is applied in deriving the resultant output string when a match is found between the first input symbol string and the first string segment in addition to the application of a first string operation to the first input symbol string; (h.) comparing an additional string segment of the first transition table with the first input symbol string; (i.) when a match between the additional string element of the first transition table and a portion or all of the first input symbol string is detected, selecting an additional string operation that is paired with the additional string element within the plurality of pairs; (j.) deriving a resultant output string at least partially on the basis of an application of the additional string operation in response to matching additional string element to a portion or all of the first input symbol string; (k.) selecting at least a portion of the first input symbol string as an operand and applying an additional mathematical operation to the selected operand and therefrom generating a result, whereby the resultant output string is at least partially derived from the result; (l.) selecting at least a portion of the first input symbol string as an operand and applying a second mathematical operation to the selected operand and therefrom generating a result, whereby the resultant output string includes the result; (m.) comparing a plurality of string segments of the first transition table with the first input symbol string, and when a match between the any string element of the first transition table and a portion or all of the first input symbol string is detected, selecting each associated string operation that is paired with any matching string element within the plurality of pairs, and deriving a resultant output string at least partially on the basis of an application of the associated operations in response to matching the at least one string element of the plurality of pairs to one or more portions or all of the first input symbol string.

Certain even alternate preferred embodiments of the invented method provide a device a comprising a processor; and a memory communicatively coupled with the processor and storing a graph database management system adapted to update a first graph database, the first comprising a plurality of nodes connected by edges, and the memory further storing executable instructions that, when executed by the processor, perform one or more operations or aspects of the invented method as disclosed in the Summary and/or the Specification of the present disclosure.

It is understood that the term symbol as expressed or referenced in the present disclosure and claims may be a numeric value, an alphanumeric value or character, or represent or signify any image or character, including any universal character encoding of UNICODE™ character encoded libraries as maintained by the Unicode Consortium Mountain View, Calif., or any other information technology standard for the consistent encoding, representation, and handling of text and/or numerical values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference within the present disclosure, to include (1.) Dominiak, D., F. Rinaldo, M. Evens, “3D Real-time Simulation of an Extended ECHO Complex Adaptive System Model,” Modeling, Identification and Control: Proceedings of the Nineteenth IASTED International Conference, pp. 414-420, February, 2000; (2.) Dominiak, D., F. Rinaldo, M. Evens, “Effects of Limited Resources in 3D Real-Time Simulation of an Extended ECHO Complex Adaptive System Model,” Proceedings from the VII International Workshop on Advanced Computing and Analysis Techniques in Physics Research, Fermi National Laboratory, Batavia, Ill., pp. 258-260, October, 2000; and (3.) Dominiak, D., “Genetic Algorithms for Agent Evolution and Resource Exchange in Complex Adaptive Systems”, UMI Dissertation Services, Ann Arbor, Mich. for the Illinois Institute of Technology, Chicago, Ill., May, 2001.

### BRIEF DESCRIPTION OF DRAWINGS

The detailed description of some embodiments of the invention is made below with reference to the accompanying figures, wherein like numerals represent corresponding parts of the figures.

FIG. 1A is a diagram of a simple node, for establishment of vocabulary and concepts relevant to the context of interest;

FIG. 1B is a diagram of a simple node network, for establishment of vocabulary and concepts relevant to the context of interest;

FIG. 2 is a block diagram of an electronic communications network in which the invented method might be practiced;

FIG. 3 is a block diagram of the first system of FIG. 2;

FIG. 4 is a block diagram of the second system of FIG. 2;

FIG. 5 is a diagram of a prior art node network example, for comparison with the invented method;

FIG. 6 is a transition table network example presenting the invented method;

FIG. 7A is a block diagram presenting a record of a node N.X of FIG. 1A as stored in the computing systems of FIGS. 2 through 4;

FIG. 7B is a block diagram presenting a record of a connection C.X of FIG. 1A as stored in the computing systems of FIGS. 2 through 4;

FIG. 7C is a block diagram presenting a record of a signal SI.X of FIG. 1A as stored in the computing systems of FIGS. 2 through 4;

FIG. 8 is a transition table of the invented method;

FIG. 9A is a first part of a symbol-by-symbol example of an incoming input signal string being compared to a reference string in utilizing a transition table such as the transition table of FIG. 8;

FIG. 9B is a second part of a symbol-by-symbol example of an incoming input signal string being compared to a reference string in utilizing a transition table such as the transition table of FIG. 8;

FIG. 9C is third part of a symbol-by-symbol example of an incoming input signal string being compared to a reference string in utilizing a transition table such as the transition table of FIG. 8;

FIG. 10 is a process chart presenting a basic overview of a network such as the network of FIG. 6 producing output from received input;

FIG. 11 is a process chart presenting the operation of a single node of FIG. 1A, as a detail of a step of the process of FIG. 10;

FIG. 12 is a process chart detailing the step of a node parsing an input signal, as referenced in FIG. 11;

FIG. 13 is a process chart detailing a further sub-detail of the parsing process of FIG. 12, wherein an input signal string of any length is searched for one or more matching instances of a symbol or sequence of symbols that is relevant to the processes of the node parsing the input signal;

FIG. 14 is a process chart detailing the step of a node performing operations in response to a parsed input signal, as referenced in FIG. 11;

FIG. 15 is a process chart further detailing the step of a node performing operations in response to a parsed input signal, as referenced in FIG. 14;

FIG. 16 is a process chart presenting an overview of an invented method of constructing and improving networks;

FIG. 17 is a process chart presenting a method for training a network by cross-breeding of generations of networks in accordance with the invented method;

FIG. 18A is the first of three diagrams presenting cross-breeding of two networks in accordance with the invented method;

FIG. 18B is the second of three diagrams presenting cross-breeding of two networks in accordance with the invented method;

FIG. 18C is the third of three diagrams presenting cross-breeding of two networks in accordance with the invented method;

FIG. 19A is the first of three diagrams presenting cross-breeding of two node transition tables in accordance with the invented method;

FIG. 19B is the second of three diagrams presenting crossbreeding of two two-node transition tables in accordance with the invented method;

FIG. 19C is the third of three diagrams presenting cross-breeding of two node transition tables in accordance with the invented method;

FIG. 20A is the first of three diagrams presenting cross-breeding of two node transition tables in accordance with the invented method;

FIG. 20B is the second of three diagrams presenting cross-breeding of two node transition tables in accordance with the invented method;

FIG. 20C is the third of three diagrams presenting cross-breeding of two node transition tables in accordance with the invented method;

FIG. 21 is a process chart regarding a preferred optimization method for the transition table networks of FIG. 6 and others;

FIG. 22 is a process chart for deriving a probable input value or values of a network such as the network of FIG. 6 from a known output value, through back propagation instead of the forward propagation of FIG. 10;

FIG. 23 is a transition table network example wherein multiple transitional networks are networked together, presenting the invented method;

FIG. 24A is a diagram portion of an example provided in FIGS. 14A, 14B, and 14C regarding use of offense and defense tags in the transition table networks of FIGS. 6, 13, and others;

FIG. 24B is a first table portion of an example provided in FIGS. 14A, 14B, and 14C regarding use of offense and defense tags in the transition table networks of FIGS. 6, 13, and others;

FIG. 24C is a second table portion of an example provided in FIGS. 14A, 14B, and 14C regarding use of offense and defense tags in the transition table networks of FIGS. 6, 13, and others;

FIG. 25A is a diagram portion of an example provided in FIGS. 15A and 15B regarding use of shadow tables in the transition table networks of FIGS. 6, 23, and others;

FIG. 25B is a table portion of an example provided in FIGS. 15A and 15B regarding use of shadow tables in the transition table networks of FIGS. 6, 23, and others; and

FIG. 26 is a representation of an invented graphical user interface for use in accessing the invented systems and practicing the invented methods.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

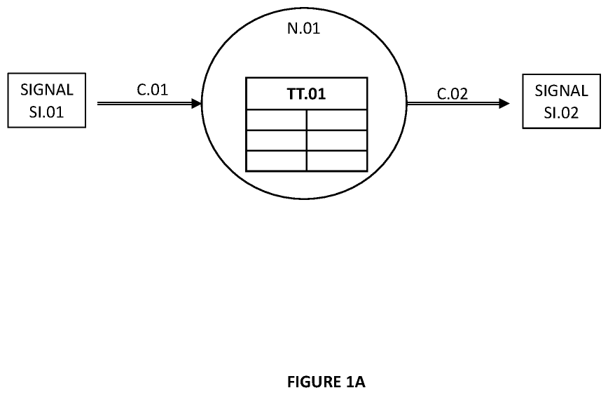

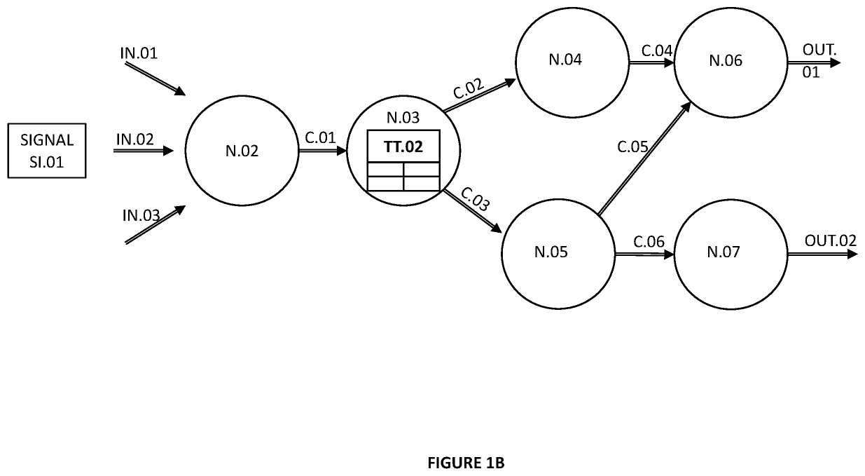

Referring now generally to the Figures, and particularly to FIG. 1A, FIG. 1A is a simple diagram for introducing the conceptual environment of interest. The diagram presents a node N.01 with an incoming connection C.01, an outgoing connection C.02, and a transition table TT.01, receiving a first signal SI.01 via the incoming connection C.01 and delivering a second signal SI.02 via the outgoing connection C.02.

It is to be understood that the prefixes of “N.”, “C.”, “SI.” and “TT.” as established in FIG. 1A may be used throughout to designate both specific, numbered instances of these classes of objects as presented in the Figures, and also to discuss these categories in general, with the suffix “.X” signifying an abstract, categorical, or arbitrarily chosen object belonging to that basic category as defined here, such as in the statement “Nodes N.X may sometimes have more than two connections C.X.”

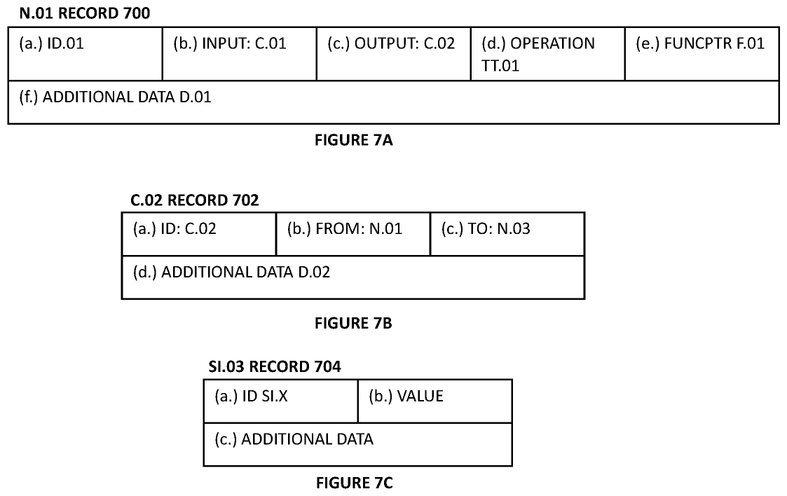

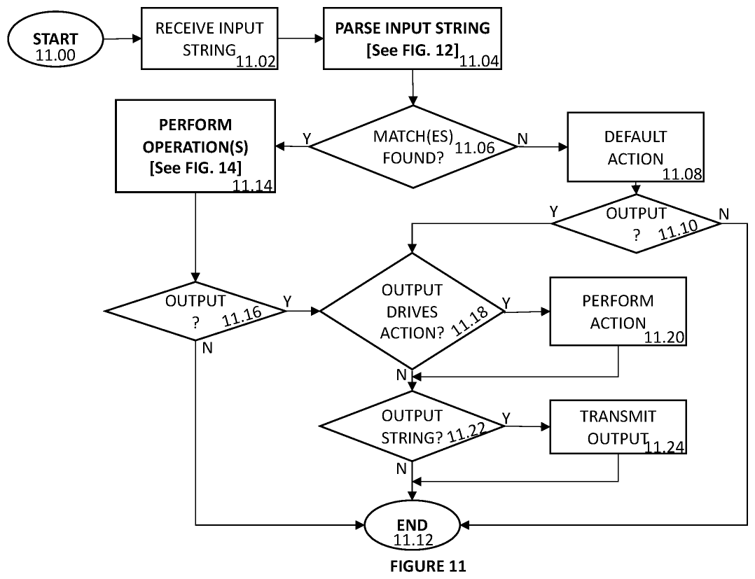

It is noted that several discussions herein may concern any/some single arbitrarily-chosen node, such as FIG. 7A, FIG. 11-15, and so on. In many of these instances, these discussions refer back to the node N.01 of FIG. 1A and other elements of FIG. 1A as a more concrete representation of this abstract ‘any-node’.

Referring now generally to the Figures, and particularly to FIG. 1B, FIG. 1B is a simple diagram for introducing the conceptual environment of interest. The diagram presents a network NET.01 (also alternatively called a graph database), which receives one or more inputs IN.01-03 (each in the form of a signal SI.01) and produces one or more outputs OUT.01-02 (each in the form of a signal SI.02). The network NET.01 comprises a plurality of nodes N.02-07, and a plurality of communicative connections C.01-06 between these nodes N.02-07. At least one node N.03, as presented here, further includes a transition table TT.02.

It is to be understood that the prefixes of “NET.”, “IN.”, “SI.”, “OUT.”, “N.”, “C.”, and “TT.” as established in FIGS. 1A & 1B may be used throughout to designate both specific, numbered instances of these classes of objects as presented in the Figures, and also to discuss these categories in general, with the suffix “.X” signifying an abstract, categorical, or arbitrarily chosen object belonging to that basic category as defined here, such as in the statement “Not all possible networks NET.X have the same number of nodes N.X as the example network NET.01 presented in FIG. 1B.” It is further noted that the suffix “.X” will never be used to designate a specific instance or element, and is reserved for this abstract descriptive purpose.

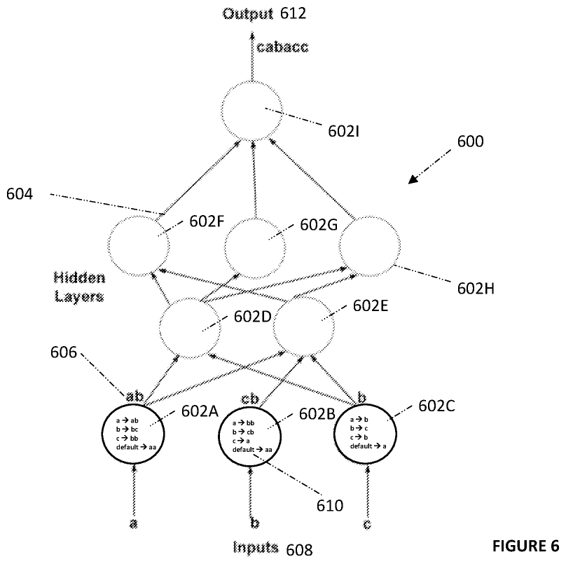

In general function of any network NET.X of this kind, one or more inputs IN.X are received by the first node(s) N.X of the network NET.X (in this diagram, the first node is designated N.01; it's also possible for a network NET.X to have more than one input IN.X or more than one first node N.X, as presented at least in FIG. 6) in the form of some kind of signal SI.X. It's common in the art for these signals SI.X to be in the form of weighted numerical values; the present invention may depart from this, and most of the signals SI.X discussed herein are in the form of strings of symbols such as alphanumeric characters. It is further noted that any input IN.X is the same thing as an instance of some signal SI.X which is provided to some network NET.X, and any output OUT.X is the same thing as an instance of some signal SI.X which is produced by some network NET.X.

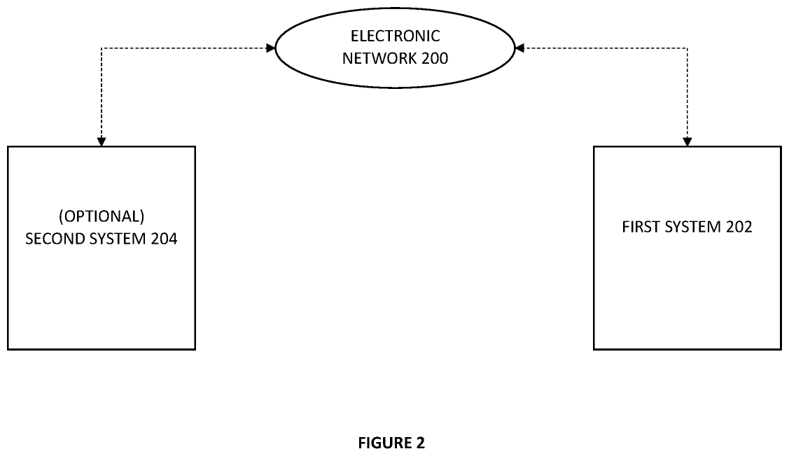

Referring now generally to the Figures, and particularly to FIG. 2, FIG. 2 is a diagram of an electronic communications network 200, comprising a first system 202 and an optional second system 204 that may assist or perform software functions pertaining to the invented method, all bidirectionally communicatively coupled by means of this electronic communications network 200.

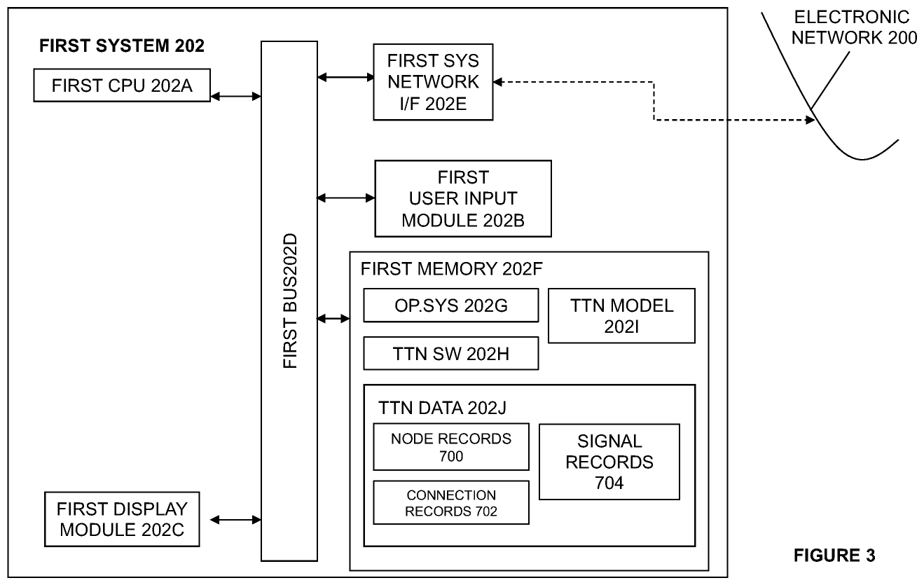

It is understood that the term “system” is being used herein as referring collectively to the hardware and software of a computer that together enable and direct this computer to make available or provide a certain service, and is being used as synonymous with the term server. Therefore, the first system 202 as presented in FIG. 2 and FIG. 3 and referenced throughout is understood to represent both a physical computer connected to the electronic communications network 200 by physical means such as a cable or wireless mechanism, and also the software hosted by this same computer that enables bidirectional data transmission and reception by means of the electronic communications network 200 in addition to software functions enabling this system's providing the service relevant to the present invention, namely software functionality in accordance with the invented method.

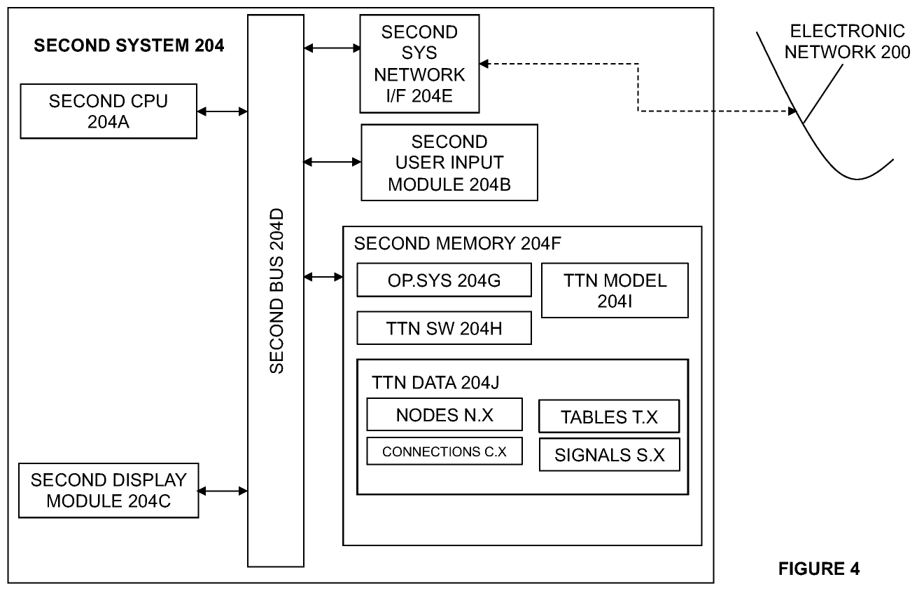

Additionally, the second system 204 as presented in FIG. 2 and FIG. 4 and referenced throughout is understood to represent both a physical computer connected to the electronic communications network 200 by physical means such as a cable or wireless mechanism, and the software hosted by this same computer that enables bidirectional data transmission and reception by means of such the electronic communications network 200, in addition to software functions enabling this system's providing the service relevant to the present invention.

Referring now generally to the Figures, and particularly to FIG. 3, FIG. 3 is a block diagram of the first system 202 of the electronic communications network 200 of FIG. 2 and displaying together both hardware and software aspects thereof, wherein the first system 202 comprises: a central processing unit (“CPU”) 202A; a user input module 202B; a display module 202C; a software bus 202D bi-directionally communicatively coupled with the CPU 202A, the user input module 202B, the display module 202C; the software bus 202D is further bi-directionally coupled with a network interface 202E, enabling communication with alternate computing devices by means of the electronic communications network 200; and a first memory 202F. The first software bus 202D facilitates communications between the above-mentioned components of the first system 202.

Alternatively, optionally and/or additionally the first system 202 and associated functions as disclosed in the present disclosure are wholly or in part are comprised within, provided within, and/or made accessible via, or directly or indirectly via the electronic communications network 200, including but not limited to a Virtual Machine and/or Platform as a Service, including but not limited to an Amazon Web Services (AWS) asset, a Microsoft Cloud (Azure) asset or service, a Google Cloud service or asset, and Oracle Cloud Infrastructure (OCI) asset or service, and/or one or more suitable internet-accessible assets or services in singularity, in concert or in combination.

The memory 202F of the first system 202 includes a first software operating system OP.SYS 202G. The first software OP.SYS 102G of the first system 202 may be selected from freely available, open source and/or commercially available operating system software, to include but not limited to IBM Power System S924 marketed by IBM, or Dell EMC PowerEdge™ Servers; or (d.) other suitable computational system or electronic communications device known in the art capable of providing networking and operating system services as known in the art capable of providing networking and operating system services as known in the art.

The exemplary first system software program for managing transitional neural networks SW 202H consisting of executable instructions and associated data structures is optionally adapted to enable the first system 202 to manage one or more software components which perform, execute and instantiate all elements, aspects and steps as required of the first system 202 to practice the invented method in various preferred embodiments, potentially in interaction with the second system 204. The TTN model 202I represents memory storage for the one or more transitional neural network models used to practice the invention. The TTN data 202J represents memory storage for other data supporting the practice of the invention, such as training data for neural networks. These components may be stored or instantiated on a single computer, shared or copied between multiple devices, or consist of multiple programs operating in coordination or separately on one or more computers. It is noted that the TTN data 202J may include the node records 700 of FIG. 7A, the connection records 702 of FIG. 7B, and the signal records 704 of FIG. 7C, and any other data or records considered necessary or preferred for implementing the invention as described herein, such as but not limited to functions to call, tables for looking up information, images, video, or audio. These same elements are represented also in FIG. 4 to emphasize that instances of these elements may be ‘located’ on any of these computing devices or both in tandem. As with many software processes, data storage details are generally irrelevant as long as things work properly and the relevant data can be accessed in order to practice the software method.

Referring now generally to the Figures, and particularly to FIG. 4, FIG. 4 is a block diagram of the second system 204 of the electronic communications network 200 of FIG. 2 and displaying together both hardware and software aspects thereof, wherein the second system 204 comprises: a central processing unit (“CPU”) 204A; a user input module 204B; a display module 204C; a software bus 204D bi-directionally communicatively coupled with the CPU 104A, the user input module 204B, the display module 204C; the software bus 204D is further bi-directionally coupled with a network interface 204E, enabling communication with alternate computing devices by means of the electronic communications network 200; and a second memory 204F. The second software bus 204D facilitates communications between the above-mentioned components of the second system 204.

Alternatively, optionally and/or additionally the second system 204 and associated functions as disclosed in the present disclosure are wholly or in part are comprised within, provided within, and/or made accessible via, or directly or indirectly via the electronic communications network 200, including but not limited to a Virtual Machine and/or Platform as a Service, including but not limited to an Amazon Web Services (AWS) asset, a Microsoft Cloud (Azure) asset or service, a Google Cloud service or asset, and Oracle Cloud Infrastructure (OCI) asset or service, and/or one or more suitable internet-accessible assets or services in singularity, in concert or in combination.

The memory 204F of the second system 204 includes a second software operating system OP.SYS 204G. The second software OP.SYS 204G of the second system 204 may be selected from freely available, open source and/or commercially available operating system software, to include but not limited to (a.) an HP Z620 AutoCAD Workstation E5-1620v2™ marketed by Hewlett Packard Enterprise of San Jose, Calif. and running a WINDOWS 10 PROFESSIONAL™ 64-Bit operating system as marketed by Microsoft Corporation of Redmond, Wash.; (b.) a Dell Precision Mobile Workstation 3551-15.6″—Core i5 10300H™ marketed by Dell Corporation of Round Rock, Tex.; (c.) a MAC PRO™ workstation as marketed by Apple, Inc. of Cupertino, Calif.; or (d.) other suitable computational system or electronic communications device known in the art capable of providing networking and operating system services as known in the art capable of providing networking and operating system services as known in the art. The exemplary second system software program SW.SRC 204H consisting of executable instructions and associated data structures is optionally adapted to enable the second system 204 to (a.) generate messages and communicate with the first system 202, (b.) communicate with and process messages received from the first system 202, and (c.) manage one or more software programs which perform, execute and instantiate all elements, aspects and steps as required of the second system 204 to practice the invented method in various preferred embodiments interacting with the first system 202.

The exemplary second system software program for managing transitional neural networks SW 204H consisting of executable instructions and associated data structures is optionally adapted to enable the second system 204 to manage one or more software components which perform, execute and instantiate all elements, aspects and steps as required of the second system 204 to practice the invented method in various preferred embodiments, potentially in interaction with the first system 202. The TTN model 204I represents memory storage for the one or more transitional neural network models used to practice the invention. The TTN data 204J represents memory storage for other data supporting the practice of the invention, such as training data for neural networks. These components may be stored or instantiated on a single computer, shared or copied between multiple devices, or consist of multiple programs operating in coordination or separately on one or more computers. It is noted that the TTN data 204J may include the node records 700 of FIG. 7A, the connection records 702 of FIG. 7B, and the signal records 704 of FIG. 7C, and any other data or records considered necessary or preferred for implementing the invention as described herein, such as but not limited to functions to call, tables for looking up information, images, video, or audio. These same elements are represented also in FIG. 3 to emphasize that instances of these elements may be ‘located’ on either of these computing devices or both in tandem. As with many software processes, data storage details are generally irrelevant as long as things work properly and the relevant data can be accessed in order to practice the software method.

The present invented method may be practiced utilizing one or more processor cores of a single computer, by utilizing a network of computers working together, or by any processor configuration known in the art for performing computer-based tasks and methods. While multiple computers and a network interface have been presented here for the sake of thoroughness of enabling disclosure, this should not be construed as an indication of minimal or maximal hardware requirement. One skilled in the art will recognize that computing devices suitable for running a software process can exist in many forms, and certain applications can be performed for instance by coordinating multiple individual ‘computers’ to act as one big ‘computer’, or scaled depending on the hardware available.

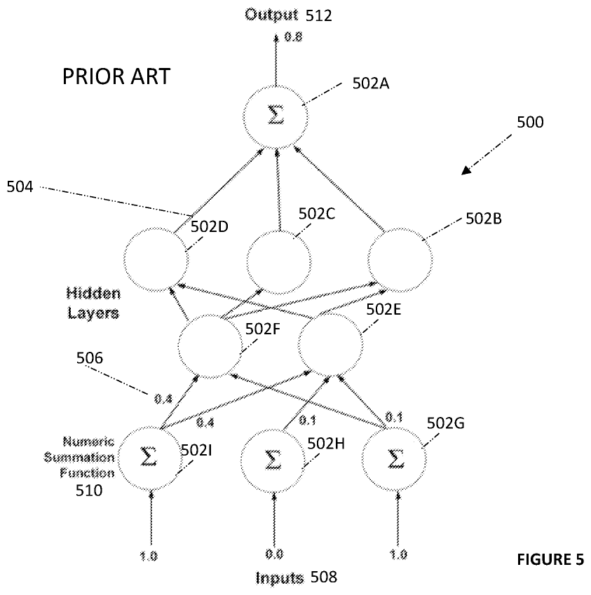

Referring now generally to the Figures and particularly to FIG. 5, FIG. 5 is a diagram presenting an example of a prior art neural net 500 consisting of a plurality of prior art nodes 502 (further sub-numbered here 502A-I) and a plurality of prior art connections 504. Note that the element labeling lines in this Figure are dashed to discourage these from being mistaken for the prior art connections 504 of the diagram, which are solid lines with arrows. In a typical neural net like the prior art neural net 500, a plurality of prior art signals 506 passed between prior art nodes 502 via prior art connections 504 are represented as numerical ‘weight’ values such as the prior art signals 506 presented here, which the prior art nodes 502 of the neural network are programmed to apply mathematical functions to, most often summing input values together. One or more prior art inputs 508 are entered into the prior art neural net 500, and propagated as passed prior art signals 506 through the prior art nodes 502 according to the prior art connections 504 and the functions applied at the nodes such as a Numerical Summation Function 510 as presented here, until the prior art neural net 500 produces one or more prior art output(s) 512. It is noted that the first three nodes 502 of the network 500 presented here have their node Numerical Summation Functions 510 visible, while other layers of nodes 502 in the network 500 are hidden for simplicity in drafting, not because these nodes 502 don't have any internal functions. It is noted that the prior art network 500 of FIG. 5 is the only network presented herein which is NOT to be considered an instance of the network NET.X as introduced in FIG. 1B, as while this prior art network 500 includes some similar features and understanding prior art may provide context, not all elements and functions of the network NET.X as presented herein are included in the prior art.

Referring now generally to the Figures and particularly to FIG. 6, FIG. 6 is a diagram representing an invented transitional table network 600, an instance of the network NET.X as introduced in FIG. 1. This transitional table network 600 includes a plurality of nodes N.602 (instances of node N.X, numbered here nodes 602A through 602I), a plurality of connections 604 (instances of C.X), a plurality of signals 606 (instances of SI.X), a plurality of input(s) 608 (instances of IN.X), a plurality of transition tables 610 (instances of TT.X) associated with the nodes 602, and one or more output(s) 612 (instances of OUT.X). A key difference between the prior art network 500 of FIG. 5 and the present transition table network 600 of FIG. 6 is in the format of the signals 606 and the type of function operating in the nodes 602. Specifically, the signals 606 being passed around in this transition table network 600 are strings of symbols such as alphanumeric characters, and these are transformed at the nodes 602 by transition tables 610 that indicate which output signal 606 to pass onward in response to any given input signal 606. A mathematical function is defined as a binary relation between two sets that associates every element of the first set with exactly one element of the second set; transition tables are functions for handling non-numeric signals 606 rather than accumulating or transforming numerical values. It is noted that in addition to the anticipated inputs of a, b, and c, each of the nodes having a transition table 610 shown here also includes a case for ‘default’, which is a rule that would be applied to any other input value, such as a ‘q’.

Referring now generally to the Figures and particularly to FIG. 7A, FIG. 7A is a block diagram representing a record of a node N.01 of FIG. 1A as stored in the computer memory systems of FIGS. 2 through 4. The node record 700 of FIG. 7A includes all of the data relevant to or preferred for instantiating and modeling any single node N.X, represented here by the example of the single specific node N.01 of FIG. 1A, such as but not limited to: (a.) an identifier such as an ID number ID.01 for reliably identifying this specific node N.01, (b.) an input connection identifier, representing association with a specific connection C.01 from which this node receives incoming signals, (c.) an output connection identifier, representing association with a specific connection C.02 to which this node delivers outgoing signals, (d.) an association with an operation such as a transition table TT.01 which codifies how this node handles signals, (e.) optionally, an association with a function and/or pointer F.01 that this node might additionally utilize to handle signals, and (f.) any other additional data D.01 that may be required or preferred, such as but not limited to additional inputs, outputs, connections, pointers, or functions. It is emphasized that the elements presented here are intended to provide enabling structure by instantiating nodes N.X also as records stored in computer memory, not to limit what nodes N.X may comprise as their data; any additional data required or preferred for implementing the node N.01 may be considered as additional data D.01. It is noted that, while a specific node N.01 is the subject matter of the presented node record 700 as a demonstrative example, these statements regarding the node N.01 as stored in the node record 700 are understood as applying to any and every node N.X which may be stored in computer memory such as the first system memory 202F or the second system memory 204F.

Referring now generally to the Figures and particularly to FIG. 7B, FIG. 7B is a block diagram representing a record of a connection C.X of FIG. 1A as stored in the computer memory systems of FIGS. 2 through 4. The connection record 702 of FIG. 7B includes all of the data relevant to or preferred for instantiating and modeling any single connection C.X, represented here by the example of a single specific connection C.02, such as but not limited to: (a.) an identifier such as an ID number ID.02 for reliably identifying this specific connection C.02, (b.) a ‘from’ node identifier, representing association with a specific first node N.01 from which this connection transmits signals, (c.) a ‘to’ node identifier, representing association with a specific second node N.03 to which this connection transmits signals, and (d.) any other additional data D.02 that may be required or preferred. It is emphasized that the elements presented here are intended to provide enabling structure by instantiating connections C.X also as records stored in computer memory, not to limit what connections C.X may comprise as their data; any additional data required or preferred for implementing the connection C.02 may be considered as additional data D.02. It is noted that, while a specific connection C.02 is the subject matter of the presented connection record 702 as a demonstrative example, these statements regarding the connection C.02 as stored in the connection record 702 are understood as applying to any and every connection C.X which may be stored in computer memory such as the first system memory 202F or the second system memory 204F.

Referring now generally to the Figures and particularly to FIG. 7C, FIG. 7C is a block diagram representing a record of a signal SI.X of FIG. 1A as stored in the computer memory systems of FIGS. 2 through 4. The signal record 704 of FIG. 7C includes all of the data relevant to or preferred for instantiating and modeling any single signal SI.X, represented here by the example of a single specific signal SI.03, such as but not limited to: (a.) an identifier such as an ID number ID.03 for reliably identifying this specific signal SI.03, (b.) the contents of the signal, such as a value or string, and (c.) any other additional data D.03 that may be required or preferred. It is emphasized that the elements presented here are intended to provide enabling structure by instantiating signals SI.X also as records stored in computer memory, not to limit what signals SI.X may comprise; any additional data required or preferred for implementing the signal SI.03, such as metadata regarding the signal SI.03, may be considered as additional data D.03. It is noted that, while a specific signal SI.03 is the subject matter of the presented signal record 704 as a demonstrative example, these statements regarding the connection SI.03 as stored in the signal record 704 are understood as applying to any and every signal SI.X which may be stored in computer memory such as the first system memory 202F or the second system memory 204F.

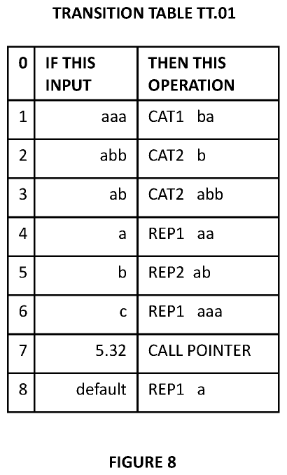

Referring now generally to the Figures and particularly to FIG. 8, FIG. 8 is a transition table TT.01 example, an instance of the transition table TT.X as introduced in FIG. 1A. A transition table TT.X may be understood as a plurality of pairs of string segments and string operations. The table is labeled with row numbers 0 through 8, and row 0 is a header row, to facilitate referring to items in the table. This transition table TT.01 may be associated with some node N.X and operate as a function table for associating an input pattern such as the “abb” of row 2 or the “c” of row 6 with an operation to be performed by the node N.X if that pattern is found in any received input signal SI.X. See the process charts of FIGS. 11 through 15 for more information about node processes.

It is noted that, as the strings of symbols ‘flow’ through the network of nodes and are built and modified according to transition tables, there are a few main varieties of transition table operations that may be common and should be clearly understood. First, Replacement: replacing part or all of a string of symbols with a different symbol or string. Second, Concatenation: appending one or more symbols onto or into existing symbol strings, which may result in creation of longer and longer strings of symbols. Concatenation would also include reduplication, that is the concatenation of a copy of all or part of the string onto or into the existing string.

It is noted that any function known in the art or yet to be discovered for manipulating strings such as char strings in general might potentially be utilized here, and this mention of two functions likely to be utilized often is not intended to be limiting or exhaustive.

As a demonstrative example using this presented table of FIG. 8, please consider an example received input string of:
aabbccd

This string can be separated into the following patterns:
a abb c d

Note that things such as the order in which patterns are searched for and whether a single symbol can be considered part of more than one pattern are relevant, and at the developer's discretion. In this example, the patterns are picked out of the string in the order they appear in the table (resulting in the second, third, and fourth characters of the input signal being parsed as an instance of “abb” instead of as instances of the “ab”, “a”, and “b” patterns of rows 3, 4, and 5), and each symbol (in this case, letter) can only belong to one pattern, as shown above.

Therefore, having parsed out these four patterns, four operations are correspondingly indicated:

| ROW | INPUT PATTERN | OPERATION | RESULT |
|---|---|---|---|
| 4 | a | REP1 “aa” | aaa |
| 2 | abb | CAT2 “b” | abb . . . b |
| 6 | c | REP1 “aaa” | aaa |
| 8 | d (default) | REP1 “a” | a |

In this example, the expression “CAT1” is used as an abbreviation for “concatenate onto the found section”, “CAT2” is used as an abbreviation for “concatenate onto the end of the signal string”, “REP1” is used as an abbreviation for “replace the found pattern”, and “REP2” is used as an abbreviation for “replace the whole string”. Therefore, a ‘long form’ recitation of the table of FIG. 8 might read:

1. If the pattern “aaa” is found, then concatenate the pattern “ba” onto the “aaa” wherever it occurs (incidentally, this would be equivalent to a REP1 “aaaba”).

2. If the pattern “aab” is found, then concatenate the pattern “b” onto the end of the signal string, no matter what the rest of the string is.

3. If the pattern “ab” is found, then concatenate the pattern “abb” onto the end of the signal string, no matter what the rest of the string is.

4. If the pattern “a” is found, then replace the found pattern “a” with the pattern “aa” (This would be equivalent to a CAT1 “a”. It is further noted that, given the ‘precedence’ mentioned earlier as stated in this example, what is actually being sought here is a single ‘a’ that is not part of a longer pattern that has already been sought).

5. If the pattern “b” is found, then replace the entire signal strong, no matter what it is, with the pattern “ab”. (This would be equivalent to essentially ignoring the input signal and spitting out “ab” as the output signal, but it is noted that doing so, in this case, is still based on having been told by the input signal to do exactly that, even if the signal otherwise doesn't ‘survive’ the transaction.)

6. If the pattern “c” is found, then replace the found “c” with the pattern “aaa”.

7. If the pattern “5.32” is found, then call a stored pointer. (Note that this is included in the example as a reminder that an incoming value could be anything and some incoming values may not be within the node's generally expected range of possible input, that unexpected input might be filtered out and handled by calling a function or redirecting it to a network better suited to that kind of input, and also that, while signals consisting of strings of symbols are the generally preferred medium in the present invented network method, a table option like this might provide a means for regulated compatibility with other varieties of networks.)

8. Else, if a pattern that doesn't match any of these is found, replace that miscellaneous pattern with “a”. (Note that “if no pattern at all is found” would be another type of default case not represented here, and also that, by replacing any letter other than “a” or “b” with a pattern consisting of only a's or b's, this node's transition table effectively guarantees that the signals after this point will consist of only the symbols ‘a’ and ‘b’.)

Therefore, the resulting output string from the example, separated by pattern, would be:
aaa abb aaa a b

Note that the final symbol “b” is the result of the CAT2 indicated by the “abb” pattern; the pattern “b” was concatenated onto the end of the signal string, not the end of the “abb”. It is further noted that more complexity in operations is possible and may be useful, such as, for example, an operation wherein, if the pattern “ac” is found, then if a second instance of “ac” is found, that instance is replaced with “bd”; or an operation where, if the pattern “cba” is found, then a “p” is appended to the next instance of “q”. Operations are not constrained to operate on the found patterns themselves.

It is noted that, though many preferred embodiments and all of the examples given herein generally use strings of alphanumeric characters, the symbols utilized to codify traits and form strings in implementation of the invention might be any suitable symbols, and are not limited to the 26-letter Latin alphabet used in English or the ten-digit set of Arabic numerals. The symbols are arbitrary values; they need not even be printable. A symbol that can be stored as an 8-bit or 16-bit value is preferred, but should not be construed as a limitation.

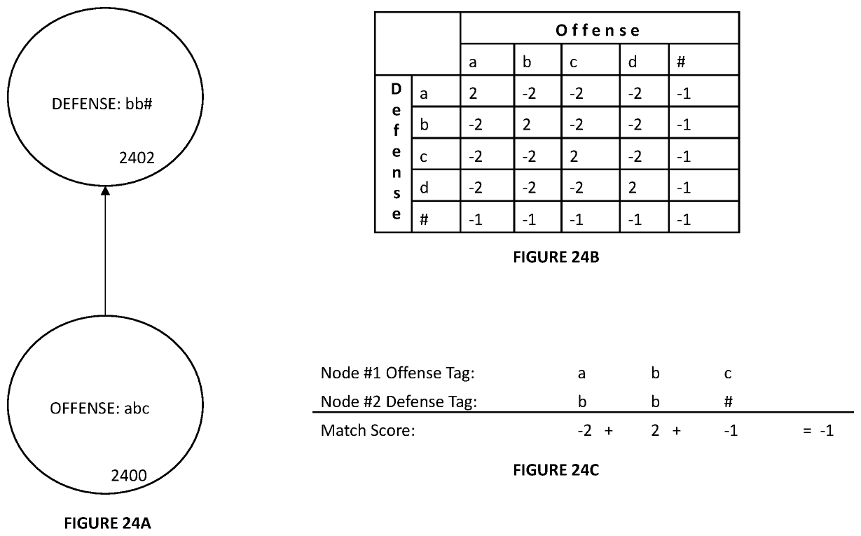

It is further noted that transformations enacted by transition tables may be conditional, and one way this may be implemented is with offense tags (output) and defense tags (input), as explicated in the thesis document incorporated herein by reference. If the offense tag (output) matches up to the defense tag (input) using this formula, the input is active. If it doesn't match, the input is turned off and/or the output reverts to the ‘default’ value. It is noted that this concept is similar to that of a Holland ECHO model. Further illustration of this concept is provided in FIGS. 24A-C.

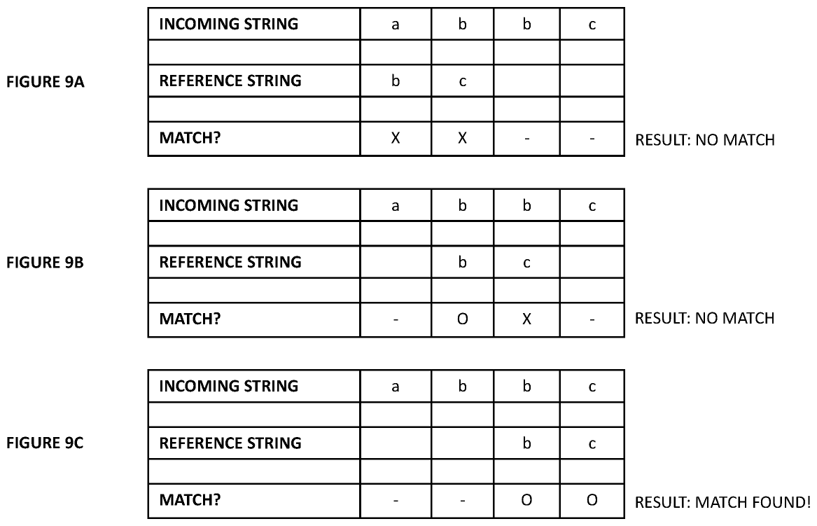

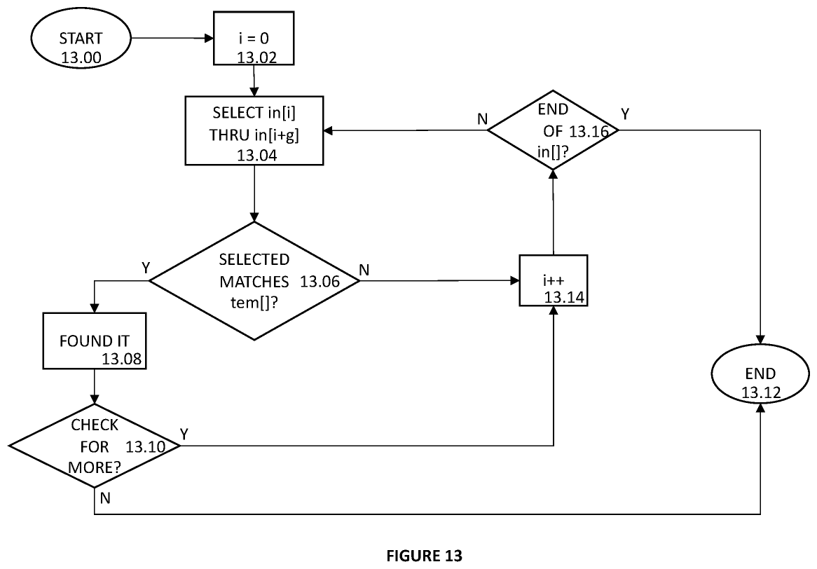

Referring now generally to the Figures and particularly to FIGS. 9A through 9C, FIGS. 9A through 9C are a symbol-by-symbol example of an incoming input signal string “abbc” being compared to a stored pattern “bc” in utilizing a transition table TT.X such as the transition table TT.01 of FIG. 8. This is in accordance with the method of FIG. 13. Note that in the “Match?” results row of the tables of FIGS. 9A-9C, “X” signifies no match, “O”, signifies a match, and “-” signifies n/a. In FIG. 9A, the sought pattern “bc” is compared to the first two symbols of the input signal string, namely “ab”. No match there. In FIG. 9B, a comparison of the sought pattern “bc” to the second and third symbols of the input string (namely ‘b’ and ‘b’) happens to yield half a match, but not a complete pattern. In FIG. 9C, the sought pattern “bc” is compared to the third and fourth symbols of the incoming string (namely, “b” and “c”); this is a found match.

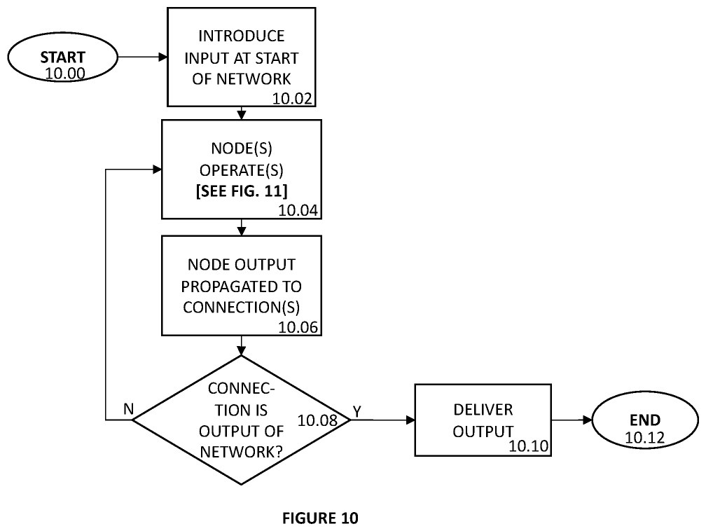

Referring now generally to the Figures and particularly to FIG. 10, FIG. 10 is a process chart presenting a basic overview of a network such as the network 600 of FIG. 6 producing output from received input. Further detail on node operations is presented in subsequent Figures; FIG. 10 might be considered the highest level of a series of ‘nesting’ process charts comprising FIGS. 10 through 16. In step 10.00, the process starts. In step 10.02, the network receives one or more input signal(s), as input signal(s) to the first node(s) of the network. Note that, as is the case in FIG. 6, there may be more than one first node or input signal. In step 10.04, the node ‘does its thing’; which is to say, the node produces one or more output signal(s) at least somewhat based on or resulting from the input signal(s) received. Once the current node has produced output, then the output signal is transmitted or propagated to one or more next nodes in the network, as connected by connections to the node producing the output. If the current node is a last node in the network, then the node output may be one in the same with the network output; step 10.08 checks for this, and if so, in step 10.10 the network's output is delivered, and in step 10.12 the process ends. If, however, the node is not at the end of the network and the output is going to subsequent nodes within the network, then the loop repeats: those subsequent nodes receiving the signal do their operations, and produce their outputs, and so on until the network is traversed from first node to last node.

Referring now generally to the Figures and particularly to FIG. 11, FIG. 11 is a process chart presenting the operation of a single node of FIG. 1A, as a detail of a step of the process of FIG. 10. FIG. 11 is the second of a series of ‘nesting’ process charts comprising FIGS. 10 through 16, and may be considered a ‘zoomed-in’ view of step 10.04 of FIG. 10 showing a process comprising the operation(s) of one node on one signal or round of signals (note that a node might be configured to accept more than one input signal at a time). The process charts of FIGS. 11 through 15 may be understood to pertain to any single node N.X and related elements, within the context of any network NET.X. The discussion of FIGS. 11 through 15 will refer to the node N.01 and other elements of FIG. 1A as a stand-in for this abstract ‘any-node’, and the element numbering of non-step elements referenced in discussion of FIGS. 11 through 15 will be based on the visual representation supplied by FIG. 1A.

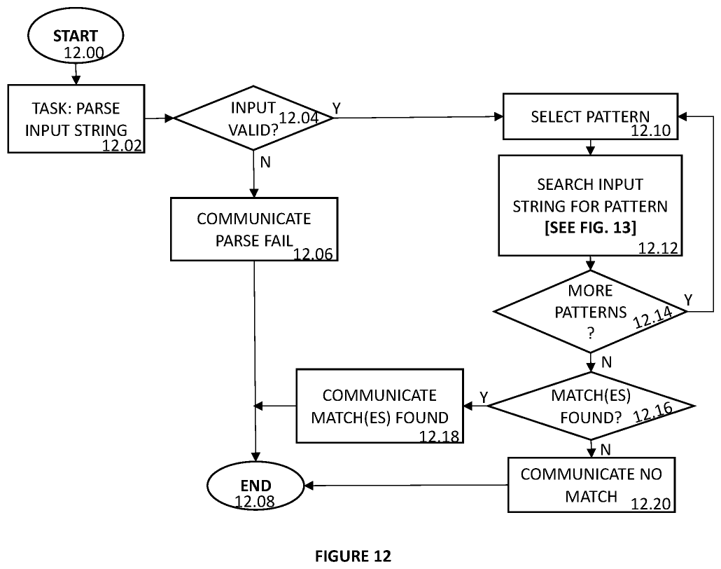

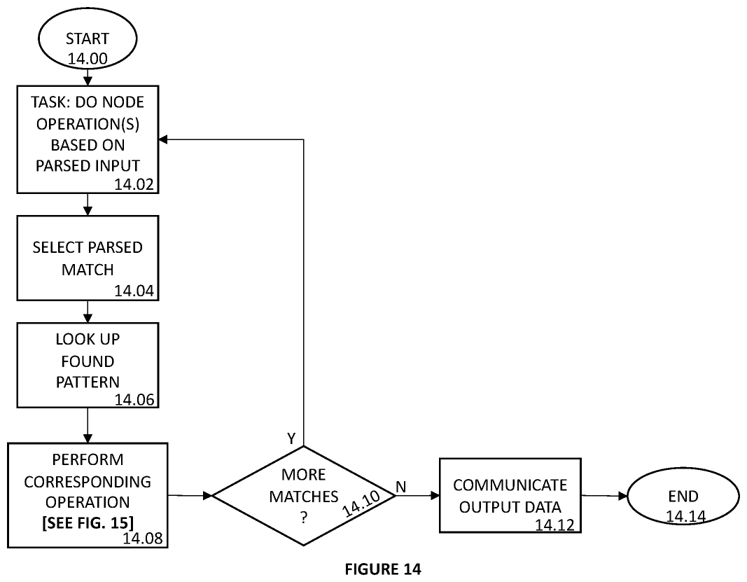

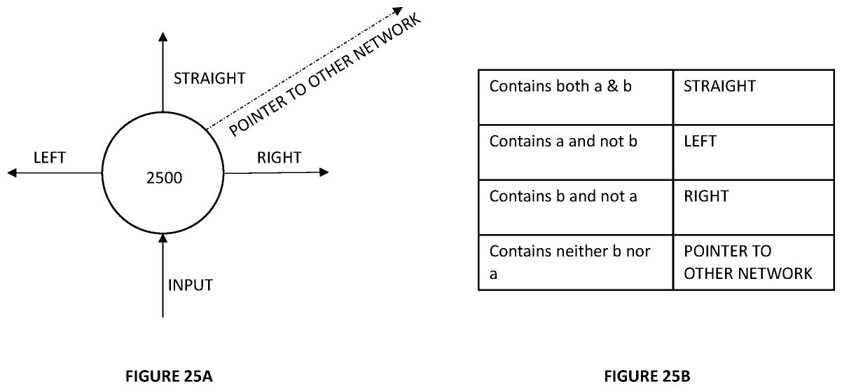

In step 11.00, the process begins. In step 11.02, an input signal SI.01 is received. In step 11.04, the received input signal SI.01 is parsed to determine what the input signal SI.01 says and whether features of the input signal SI.01 indicate for the node N.01 to do certain operations; see FIG. 12 for further detail regarding parsing the input signal SI.01; and one notes also the conditional operations of FIG. 8, wherein an operation is applied as a result of discerning a pattern match such as through the process of FIGS. 9A-9C. In step 11.06, if the input signal as parsed does not match any criteria for performing node operations, then in step 11.08, a default action is performed instead; this may be anything, but as a plausible example, this might be something like a ‘pass-through’, where the signal SI.01 is passed along as output without being modified, as no criteria have been met which justify modifying the signal SI.01, or disregarding whatever weird, unexpected, or incompatible signal was received that didn't fit the profile of anything this node N.01 usually operates on, and passing along a null or neutral signal SI.02 instead, or perhaps even not passing along an output signal SI.02 at all, making this node N.01 a ‘dead end’ based on having received a bad signal if appropriate to the context. Note also that node operations and criteria may vary; one node's ‘bad’ signal may be the perfect signal for some other node, and in fact diversity in which nodes N.X handle what and how may often be key to constructing sophisticated artificial intelligence algorithms using the methodology of the present invention. If there's no output signal SI.02 to pass along, then that's determined at step 11.10 and the process may end there at step 11.12; otherwise, regardless of provenance, some output signal SI.02 (or signals) has been produced and the process continues with this as the signal SI.02 to be outputted. Returning to the other side of the conditional step 11.06, if the input signal includes one or more matching patterns signifying that the node N.01 should perform operations based on receiving this input signal SI.01, then the node N.01 performs the one or more indicated operations; for further detail on this step, see FIG. 14. Once all of the indicated operations have been done, like with step 11.10, the result may be some output signals SI.02, one output signal SI.02, or even none (a ‘dead end’, as mentioned before); if there's no output signal to send along, the process ends at step 11.12. Otherwise, as of step 11.18, there is an output signal SI.02 as a result of the node operations or lack thereof, and that output signal may need to be sent to the next node, and may also indicate some other action, such as sending the signal to one connected node instead of another, calling a function, or something else; for more about these other node actions besides passing the signal, see FIGS. 25A-B regarding ‘shadow tables’. If the node output obtained drives an action, then at step 11.20 that action is performed. Regardless, at step 11.22, if there is an output signal, that signal is delivered to whatever appropriate connection as the output signal of this node at step 11.24. Either way, the process ends at step 11.12 . . . and, per the process chart of FIG. 10, may be repeated by the next node which just received that output signal as its input signal, and so on through the whole network. It is noted that, while this discussion may discuss nodes N.X taking actions or doing operations, all of that would really be done by the software and code modeling the nodes N.X, not by any actual nodes N.X themselves, strictly speaking.

Referring now generally to the Figures and particularly to FIG. 12, FIG. 12 is a process chart detailing the step 11.04 of a node parsing an input signal, as referenced in FIG. 11. FIG. 11 is the third of a series of ‘nesting’ process charts comprising FIGS. 10 through 16, and may be considered a ‘zoomed-in’ view of step 11.04 of FIG. 11, showing a process comprising the parsing step of one node N.01. These charts divide node operations into two phases: PARSING, wherein the signal is read and it is determined through pattern-matching whether the incoming signal is relevant to operations that the node might perform (and vice versa), and OPERATION, wherein the one or more transformations or operations indicated as appropriate to apply (based on the parsing already done) are applied. It is noted that a less formally structured approach may be preferred in some cases, such as finding a pattern and performing the indicated operation immediately without checking for any other relevant patterns first, and this may be an appropriate approach, depending on the preferred results. This ‘two phases’ approach is suggested as a generally strong programming strategy for reducing likelihood of undefined behavior, but is not compulsory or essential to practice the invention as disclosed herein. FIG. 12 might be understood as an encapsulation of that first phase in this two-part phase model, Parsing. At step 12.00, the process begins. At step 12.02, it is established or postulated (as a prerequisite for sensibly performing this process at all) that there is an input signal SI.01, and the input signal SI.01 needs parsing. At step 12.04, it is determined whether the input signal SI.01 is valid input. It is noted that this step, while not entirely compulsory, also represents good programming practice, as algorithms that blindly accept any variety of input without screening for ‘junk’ input tend to be unstable; things like datatypes and protections against segmentation faults exist for that general reason. If the input signal SI.01 is invalid, this is considered an error or parsing fail, and at step 12.06 that case is handled appropriately and the process ends at step 12.08 without further parsing. This case may necessitate handling at the ‘next level up’ in FIG. 11, such as considering this a ‘no match’ situation, disregarding the input completely, throwing to error handling, or crashing out of the program if appropriate. All of this would be at the discretion of the programmer, and represents incorporation of general good error-handling practices as known in the art. At step 12.10, a first pattern is selected for comparison to the elements of the signal. With reference to the transition table of FIG. 8, this might be the “aaa” of row 2 in the “If This Input” column; the parsing process is setting out to determine whether the incoming signal SI.01 being parsed includes the pattern “aaa”, to determine whether the node N.01 should perform the operation corresponding to that selected pattern. In step 12.12, the signal is searched for the selected pattern; see FIGS. 9A through 9C and FIG. 13 for more detail regarding this step. In step 12.14, if there are multiple patterns to search for, another pattern may be selected to search for next, until all of the patterns of the transition table TT.01 of this node N.01 have been checked for. In the course of this, the parsing algorithm may have found that only one pattern matched, that there were several matches, or that there were no matches; in step 12.16, it is determined whether to communicate that there were matches found, or that there were none. If matches were found, the parsing algorithm may communicate in step 12.18 regarding which ones, how many, where in the signal the matches are located, and other information that may be necessary to perform the node operations; if no match is found, the parsing algorithm may communicate in step 12.20 that no match was found; either way, the process ends at step 12.08 with all parsing of the present input signal SI.01 completed. It is noted that, if multiple signals were received, this process may be repeated more than once.

Referring now generally to the Figures and particularly to FIG. 13, FIG. 13 is a process chart detailing a further sub-detail of the parsing process of FIG. 12, step 12.12, wherein an input signal string of any length is searched for one or more matching instances of a symbol or sequence of symbols that is relevant to the processes of the node parsing the input signal. FIG. 13 is the fourth of a series of ‘nesting’ process charts comprising FIGS. 10 through 16. The following variables are used in this process chart:
an input string SI.01 named in[ ] which might be any number of symbols in length,
an index position i within the input string in[ ], and
a pattern string tem[ ] of length g.

In the process of FIG. 13, the parsing algorithm of the node N.01 to which this process belongs is attempting to determine whether the incoming string in[ ] contains a sought pattern tem[ ], per FIG. 12. Since the incoming string in[ ] may be longer than the pattern string tem[ ], or even contain multiple instances of the pattern, the algorithm of this process chart is provided as a suggested method for searching the entire incoming string in[ ], regardless of length, for any and all instances of the pattern string tem[ ]. It is noted that FIGS. 9A through 9C are a visual representation of this concept.

At step 13.00, the process starts. In step 13.02, the increment value i for indexing through the input string in[ ] is set to 0; i.e., the process starts with selecting the first symbol in the string in[ ]. As the search progresses, the index i will be incremented. In step 13.04, the substring comprising in[i] through in[i+g] is selected; that is, starting at the present index in the incoming string, a substring the same length as the tem[ ] pattern being matched is selected. If there is a match in the string starting at the current position i, the selected substring will be identical to tem[ ]. Note that g is the length of tem[ ]. In step 13.06, it is determined whether the currently selected substring of step 13.04 is in fact identical to tem[ ]. If so, at step 13.08 it is registered that a match has been found. In step 13.10, it is determined whether to look for more matches; in some cases, one might be enough, but in others, how many matches and/or where the matches may be just as relevant. If no more matches are sought, then the process ends at step 13.12. Otherwise, it has been determined that the process is looking for additional matches, and thus, should continue iterating through the input string in[ ] to find more. Either not finding a match or finding a match but looking for more matches leads to the same step: incrementing the index i by one, and continuing to search through the string in[ ] for matches. It is noted that the coding expression “i++” is equivalent to “i=i+1” or “let the value of i be increased by 1”. At step 13.16, a check is done to ensure that incrementing i does not result in reaching the end of the input string; incrementing beyond the end of a string can produce segmentation faults and similar, and is generally to be avoided in good coding practice. Not only is it good practice to check whether in[i] itself is the end of the string, but also whether in[i+g] is the end of the string; if step 13.04 selects symbols beyond the end of the string, that's also not generally preferred. Once the end of the input string in[ ] is reached and the answer to step 13.16 is yes, then the entire string has been searched and the process ends. It is noted that the end step 13.12 may include some communication or ‘function return’ equivalent, such that the results of this process are delivered back to the process of FIG. 12. It is noted that the string-searching algorithm outlined in FIG. 13 is just one simple example of how this task might be performed, and many algorithms for searching character strings and bodies of text are known in the art of programming in general and another may be found preferable to this one.

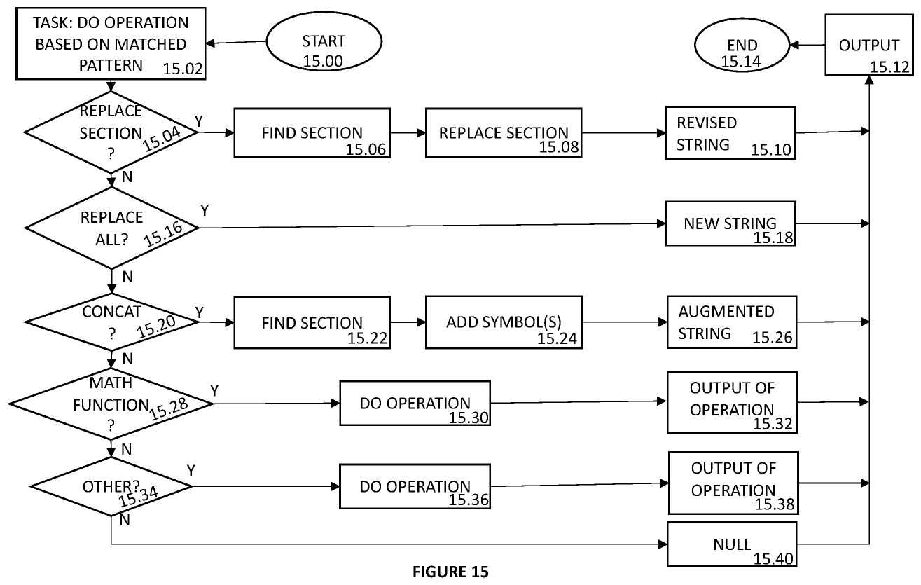

Referring now generally to the Figures and particularly to FIG. 14, FIG. 14 is a process chart detailing the step of a node performing operations in response to a parsed input signal, as referenced in FIG. 11. FIG. 14 is the fifth of a series of ‘nesting’ process charts comprising FIGS. 10 through 16, and may be considered a ‘zoomed-in’ view of step 11.14 of FIG. 11 showing a process comprising the ‘perform operations’ step of one node. The process starts at step 14.00. At step 14.02, it is established that the present task is performing one or more node operations based on the input signal as parsed in step 11.04. At step 14.04, a current pattern match is selected; there may be multiple pattern matches to perform operations in response to, but these may be addressed one at a time. It is noted that a ‘one at a time’ approach to this is a good explanatory context, but elements such as parallelization and multiple processor cores may allow a computer performing this task to work on more than one operation at once. As real-life symbol-string signals of this kind may be thousands of symbols long instead of explanatory examples five symbols long, this could be very beneficial. In this simple example, though, the operations are being handled one at a time. Having in hand information about a found pattern, in step 14.06 the transition table TT.01 of the node N.01 is referred to, to determine what operation should be done in response to that found pattern. In step 14.08, the operation is performed, for more detail, see FIG. 15. Once the operation is complete, at step 14.10, it is determined whether more matched patterns need addressing, or whether the operations are complete. If there are no more matches, the output signal is complete and in step 14.12 gets communicated to wherever the output signal should be sent, and the process ends at step 14.14.

Referring now generally to the Figures and particularly to FIG. 15, FIG. 15 is a process chart further detailing the step of a node performing operations in response to a parsed input signal, as referenced in FIG. 14. FIG. 14 is the fifth of a series of ‘nesting’ process charts comprising FIGS. 10 through 16, and may be considered a ‘zoomed-in’ view of step 14.08 of FIG. 14 showing a single operation being performed. It is noted, as a point of visual organization, that the process chart of FIG. 15 is loosely organized into columns, wherein the leftmost column of diamonds (steps 15.04, 15.16, 15.20, 15.28, and 15.34) checks for what operation should be done, a column of rectangles toward the right-hand side (steps 15.10, 15.18, 15.26, 15.32, 15.38, and 15.40) each indicate the result obtained from the operation of that ‘line item’, and any intervening steps to obtain that result are interspersed between these vertical columns. While it's not necessary to understand this visual organization in order to read FIG. 15, it is hoped that these design elements may make the chart more intuitive for the viewer to read when understood.

In step 15.00, the process starts. In step 15.02, the task is established of doing a single operation based on an instance of a matched pattern. In step 15.04, it is determined whether the operation to be performed is in the nature of replacing a section of the input string with a different symbol pattern. If so, in step 15.06, the section to be replaced is located, in step 15.08, the section is replaced, and in step 15.10, the output result is a revised version of the input string wherein a symbol or series of symbols has been replaced. If this was the operation to be performed, that output string is delivered at step 15.12, and the process ends at step 15.14. Otherwise, the operation to be performed might be to replace the entire string with a different symbol or symbols; this is determined in step 15.16. In this case, the input string may simply be disregarded, aside from its contents indicating the replacement in the first place. The resulting output, at step 15.18, is effectively a whole different string. Otherwise, at step 15.20, it is determined whether the operation is a concatenation operation, wherein one or more symbols is/are appended into or onto the input signal string. If so, then in step 15.22, the appropriate location for the new symbol or symbols to be appended is located, in step 15.24 the new symbol or symbols are appended, and in step 15.26 the output result is an augmented version of the input string, containing all of the same symbols as the unaltered string plus the new symbol(s) just added. Otherwise, the operation to be applied may be a math function; this is determined in step 15.28, applied in step 15.30, and in step 15.32, the resulting output is the result of that applied operation. Otherwise, the operation to be applied may be something else not mentioned, or may be nothing; this is determined at step 15.34. It is noted that the menu of operations offered in this Figure should not be construed as exhaustive or limiting as to what kinds of operations are possible or intended. If some other operation is indicated, then in step 15.36, that operation is performed, and in step 15.38, the result of that operation is applied as the output of the process of FIG. 15. Finally, if no operation is indicated—note that a pattern match has been found, but having matched that pattern indicates a no-op—then the result is a NULL. Note that in some cases, a null operation may be executed as a pass-through, i.e., the input string is not modified, and is passed along as the output string. In other cases, there may be a symbol or signal that is designated to represent ‘null’ for a purpose like this. This would be up to the developer's discretion. It is noted further that a ‘pass-through’ could also be constituted as an ‘other’ operation of step 15.34 (namely a copy or duplication: set the output signal to be identical to the input signal), therefore allowing for a different ‘null’ function if no operation is indicated. It is further noted that order of operations may be relevant in cases where multiple operations are indicated, depending on the operations involved; the process of FIG. 15 executes one operation, with the assumption that whatever operation is indicated by the current pattern is the appropriate operation to do next.

Referring now generally to the Figures and particularly to FIG. 16, FIG. 16 is a process chart presenting an overview of an invented method of constructing and improving networks. It is noted that, as the ‘nesting’ model of FIGS. 10 through 16 goes, FIG. 16 may be considered at a macro level above the operation of a single network of FIG. 10; note that step 16.16 encapsulates the process of FIG. 10. FIG. 16 is a process chart for (1.) constructing a network and (2.) improving the ‘raw material’ of the initial network.

Since this discussion regards construction of networks NET.X in general but may benefit from a specific visually-represented network to refer to, this discussion may be considered as regarding originating and modifying the example network NET.01 of FIG. 1B, and elements in this discussion will be numbered with reference to FIG. 1B.

In step 16.00, the process starts. at step 16.02, the task is undertaken of building the network NET.01, then improving/modifying the network NET.01. It is noted that the slightly redundant “TASK:” step often provided as the second step of a process chart herein is generally intended as a simple way to indicate ‘in a few words, here's what this process chart is going to be doing’. In step 16.04, one or more nodes N.X (particularly the nodes N.01 through N.06 in the case of the network NET.01 of FIG. 1B) are defined for the network NET.01 being built. Further, in step 16.06, one or more operations, including one or more transition tables TT.X, are defined for use by these defined nodes N.01 through N.06. Further, in step 16.08, one or more connections C.X between the nodes N.X of step 16.04 are defined; in FIG. 1B, these are the connections C.01 through C.06. The various elements defined in steps 16.04 through 16.08 constitute the basic ‘pieces’ of the network NET.01 being constructed; in step 16.10, these elements may be assembled into the network NET.01, which may include indicating also where the network's input IN.X and output OUT.X elements might be. At step 16.12, it is determined whether the network NET.X is complete (as a rough draft, anyway) or whether more items should be added, such as more nodes N.X, more connections C.X, and so on. It is noted that having instantiated this plurality of nodes N.X, connections C.X, and other elements of the network NET.X will have also included handling of any supporting tasks for setting these up, such as allocating computer memory for storing the appropriate data structures. It is noted that the steps 16.04 through 16.12 may be rearranged, or further subdivided, such as assembling the network NET.01 one node or connection at a time. This sequence or subdivision of the basic steps of originating nodes N.X, etc. and building them into a network NET.X shouldn't be construed as exhaustive or limiting.

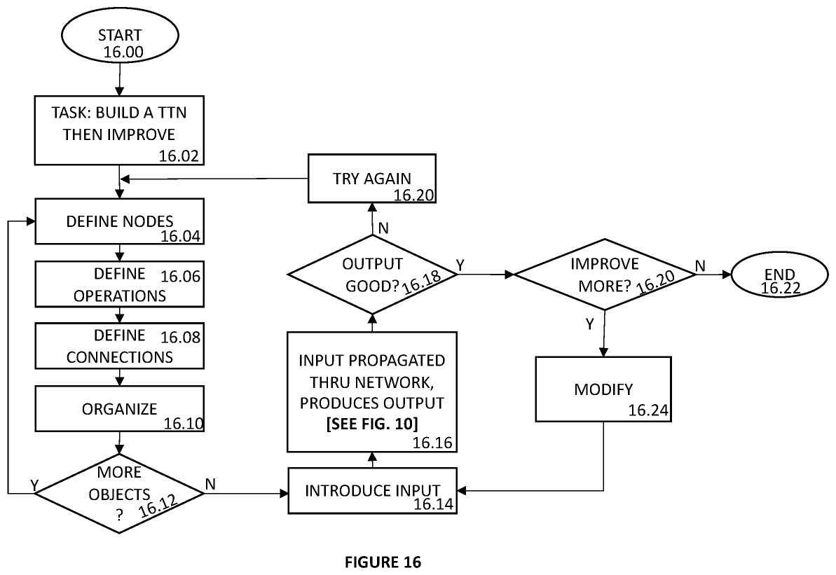

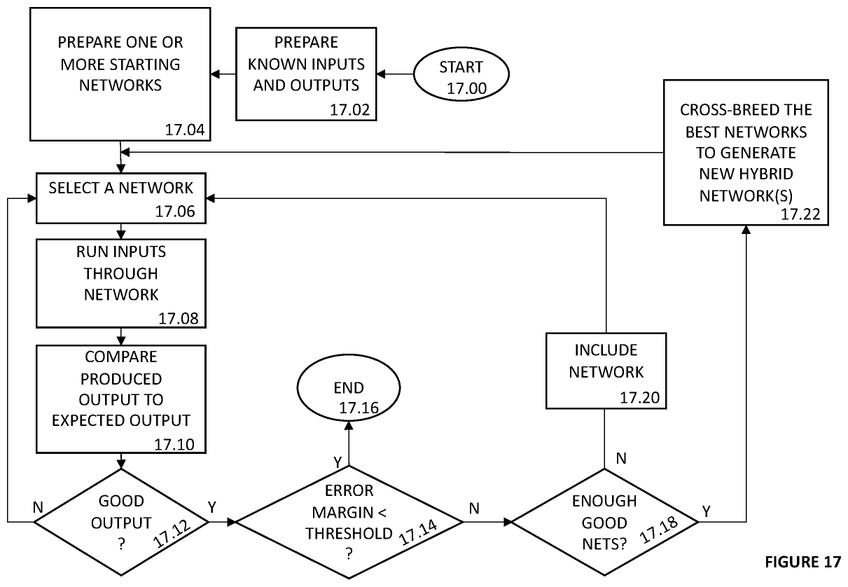

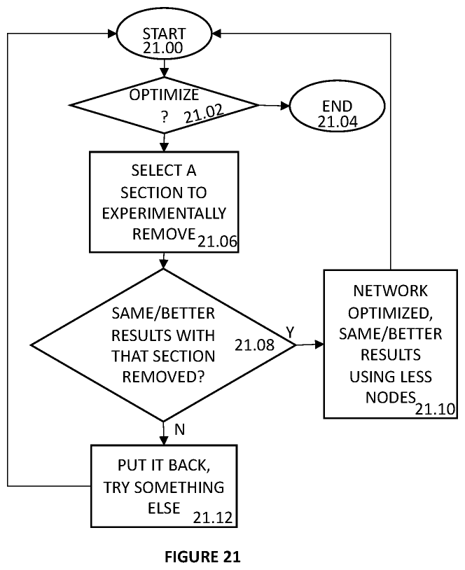

Once the network NET.01 is constructed, then at step 16.14, an item or set of input data may be ‘fed to’ the newly constructed network NET.01. This may be a simple sanity check for the cohesion of the network NET.01 once freshly built; might be random data, just to see what the network NET.01 makes of it; or the preferred output data may already be known, such that the output produced by the network from the input data provided might be an indicator of how ‘good’ the network NET.01 is at performing some intended task. In step 16.16, the network NET.01 processes the received input data IN.01-03 and produces output data OUT.01-02, per FIG. 10 and FIG. 1B. In step 16.18, it is assessed whether the output data OUT.01-02 was good enough to keep the assembled network NET.01 instead of scrapping the network NET.01 and trying again; note that in a method where a large pool of networks NET.X may be generated at random, then screened for a certain threshold of happening to turn out well, this ‘try again’ loop may be circulated through frequently. If the network NET.01 is assessed to be good enough to improve upon, at step 16.20, it is determined whether the network NET.01 should be improved further; this cycle of modification/optimization might theoretically be endless, or might be repeated until a certain threshold of quality is reached. If the network NET.01 is already very good, then it might be opted that this network NET.01 has reached the ‘final draft’. It is noted that, in an AI context, this might be the point at which the network NET.01 is good enough to graduate beyond training data and start functioning ‘in the real world’. If so, the process ends at step 16.22. If further optimization is preferred, then at step 16.24, the network NET.01 is modified in the pursuit of further improvement. It is noted that this modification might be in the form of cross-breeding as explicated in FIGS. 17 through 20C, might be removal of select sections in the manner of FIG. 21, or might even be a manual modification by a user or developer.

Referring now generally to the Figures and particularly to FIG. 17, FIG. 17 is a process chart presenting a method for training a network such as the transitional table network 600 of FIG. 6 by cross-breeding or hybridizing networks. In step 17.00 the process starts. In step 17.02, training data is prepared comprising input to provide to the network(s) and expected output for each set of input. In step 17.04 an initial generation of networks is provided. It is noted that FIG. 16 more specifically states individual steps of generating a network, such as in steps 16.04-16.12; FIG. 17 eschews this already-explicated level of detail, and simply states that an initial generation consisting of a plurality of networks is provided. This may be one or more randomly-generated networks, one or more networks obtained from somewhere else; a mixture of these, or something else; by whatever provenance, one or more network(s) with which to ‘seed’ the process are provided or generated. It is noted that, even if the starting networks are generated randomly, the invented method for generating and improving networks described herein is a winnowing/evolution process, that will seed subsequent generations or batches of networks used in subsequent iterations with aspects of the most preferred networks of this current generation. Much like the biological process of evolution, diversity and variation within any given generation of a population may vary randomly, but which individuals within that generation are most successful and pass their genetics on to the next generation most, will depend on how well suited to the environment those individuals are, resulting in a subsequent generation wherein a higher percentage of the population includes the same traits that were most advantageous for an individual to have in the previous generation. In step 17.06, a network is selected to be tested. In step 17.08, the prepared inputs are fed into the selected network. In step 17.10, the network produced an output and this output is compared to the prepared output corresponding to the input provided in step 17.08. In step 17.12, if this output result was poor, then the process returns to step 17.06 and selects a next network to test; otherwise, the output result was at least decent enough to use this network as a building block for coming up with an even better one. In step 17.14, the end condition is checked for; once this process has been repeated enough, the margin of error for at least one network may be such that this network is good enough to ‘graduate’ from training and end the process at step 17.16. Otherwise, this network was good enough to propagate, but not good enough to consider trained. In step 17.18, once this process has looped a few times, there may be enough networks tested as ‘good enough to build with’ that it's time to do some building; otherwise, the current tested network is flagged or ‘banked’ for future use, and a next network is selected for testing to keep building the pile of networks in the current generation considered good enough to build the next generation of networks from. It is noted that the number of networks needed to produce the next generation is entirely dependent upon the parameters set by a user operating the training. The user might set the process to generate another generation as soon as two candidates are stacked up, might delay and wait for a larger pile to combine randomly for a more diverse new ‘generation’, or might even cross-breed using just one preferred network and hybridizing the one with randomly-generated other networks, thus improving the chances of the hybridized random networks by making some or all of these at least partially based, a priori, on a ‘tried-and-true’ network. In step 17.22, the ‘good’ network(s) previously flagged, saved, or sorted out of the group as good enough to build with, are cross-bred or recombined to produce a new generation of network(s). These new networks, though based on an improved ‘gene pool’, are untested, so a new loop is initiated at step 17.06 wherein a new network is selected to test. It is noted that in this ‘training’ process, the individual networks themselves are not modified at all; this is more of a ‘survival of the fittest’ or selective breeding kind of winnowing process, where the networks that produce poor output are simply discarded or ignored, and the ones that produce good output are re-combined and further varied upon to improve chances of producing at least one network that may give even better output. Note also that what constitutes ‘good’ or ‘better’ output depends on what one is trying to get the network(s) to do; one might even use the same first-generation batch of networks, but change the selection criteria, and end up producing different subsequent generations of networks based on the individuals in the first generation who did best at the new selection criteria instead of the old selection criteria.

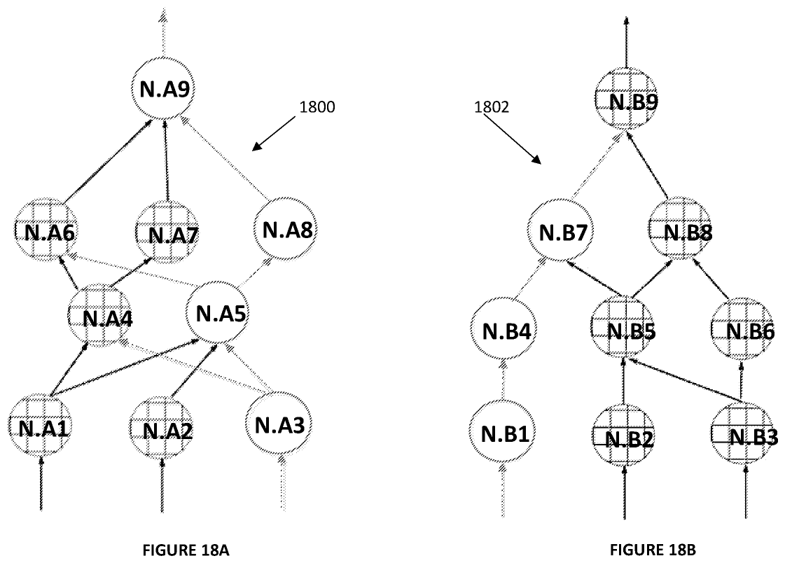

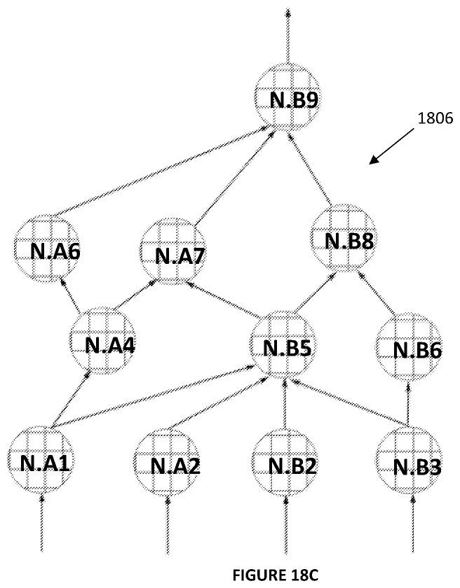

Referring now generally to the Figures and particularly to FIGS. 18A, 18B, and 18C, FIGS. 18A, 18B, and 18C are a three-part demonstration regarding the concept of cross-breeding networks such as transition table networks 600. One might consider the case that each of these two networks presented in FIGS. 18A and 18B respectively, a first network 900 of FIG. 9A consisting of a plurality of nodes N.A1-N.A9 and a second network 902 of FIG. 18B consisting of a plurality of nodes N.B1-N.B9, have been individually developed to perform reasonably well at a same given task. In this example, the two networks are hybridized together, to form a combined network 906 as presented in FIG. 18C that contains nodes and structures from both networks 900 and 902.

A method to cross-breed a transition table network is as follows. Start with two transition table networks 600, such as the exemplary networks 1800 and 1802 presented in FIGS. 18A and 18B. Randomly select a link between any two nodes 602 in the first network. Divide the network into 2 parts. Repeat this process with the second network. There are now four network fragments. Namely, in the presented example, a first fragment consists of nodes N.A1, N.A2, N.A4, N.A6, N.A7, and the connections C.X attached to these nodes; a second fragment consists of nodes N.A3, N.A5, N.A8, N.A9 and the connections C.X attached to these nodes; a third fragment consists of nodes N.B1, N.B2, N.B7, and the connections C.X attached to these; and a fourth fragment consists of nodes N.B2, N.B3, N.B5, N.B6, N.B8, N.B9, and the connections C.X attached to these. Take the first fragment of the first network and combine the first fragment with any fragment of the second network. Now take the two remaining fragments and combine them. There will be two resulting new networks. The original network and the two ‘children’ (new networks) will carry on into the next generation of networks to be evaluated.

One aspect of artificial networking, neural or otherwise, is a level of complexity that makes it difficult to quantify exactly why a neural network performs a task successfully enough to produce a correct output. What's been developed is a coping strategy effective enough to pass a given test with a certain percentage level of accuracy; any strategy will do, even a really bizarre or inefficient one with extraneous steps, as long as the criteria for coping (i.e., getting the right answer) are met. The patterns or correlations found and used might be entirely different from the criteria a human observer, or another network trained to do the same thing, might single out as key indicators for getting the right answer. This is at least part of what makes cross-breeding of networks valuable, as portions of different successful strategies can be merged and recombined, potentially producing even better combined strategies than either algorithm came up with individually. It is noted and understood that multiple combinations are possible from the same two networks, of which only one out of many possible combinations is presented here.

A genetic algorithm practiced through cross-breeding of networks is a preferred method of training a transitional table network. In this mode, a plurality of networks is generated, maybe even randomly, and the same input(s) fed into each of the generated networks. The output of each network is compared to a preferred output, and the network(s) that produced the closest match to the preferred output are used to generate the next group of networks to be tested, and so on. One might think of this process as analogous to biological evolution, wherein the genetic material of the most successful organisms of a population is the most likely to be propagated into the next generation of that population, having been mixed, matched, and diversified (by the processes of meiosis and biological reproduction) into further variations, the most successful of which will be propagated in turn.

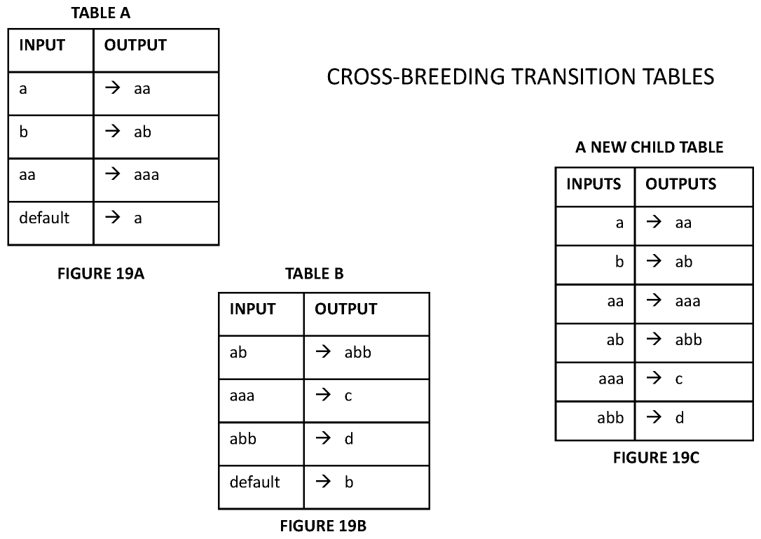

Referring now generally to the Figures and particularly to FIGS. 19A, 19B, and 19C, FIG. 19A presents the transition table 610 “A”, and FIG. 19B presents the transition table 610 “B”. Each of these transition tables 610 might be the processing formula for some node 602 of some transition table network 600. FIGS. 19A, 19B, and 19C present an example of these transition tables 610 of FIGS. 19A and 19B being hybridized together into the combined transition table 610 of FIG. 19C. In this instance, the combining results in the contradictory default case being omitted from the resulting hybrid table, and the rest of the non-overlapping cases being combined into a single listing. Other methods of combination are obvious possibilities, such as intersection, union, or random; the latter is presented in the following Figures.

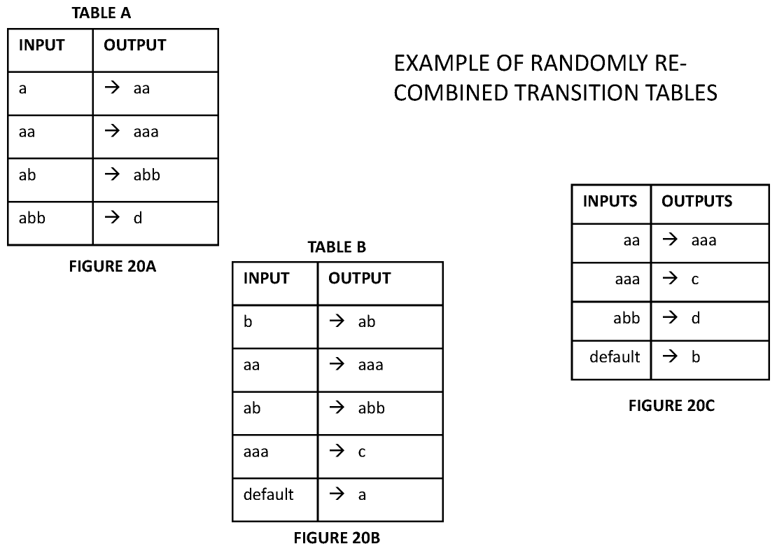

Referring now generally to the Figures and particularly to FIGS. 20A, 20B, and 20C, FIGS. 20A, 20B, and 20C are a second example of hybridizing transition tables, this time randomly. Random entries from the transition tables 610 of FIGS. 20A and 20B are carried over into the randomly combined table of FIG. 20C.

Referring now generally to the Figures and particularly to FIG. 21, FIG. 21 is a process chart presenting a method for optimizing any instance of the network NET.X such as the transition table network 600 of FIG. 6 once built, such as by reducing complexity and eliminating extraneous or nonessential nodes. In step 21.00, the process starts. In step 21.02, it is decided whether to optimize or not; if not, in step 21.04, the process ends. Otherwise, optimization is undertaken. In step 21.06, a section is selected to experiment with by removing; this may be a single node, or a cluster of them. The selection may be done by careful statistical analysis, as outlined further below, or might even be selected at random to see what happens. A set of input whose usual output is known, is run through the modified network. In step 21.08, it is determined whether the result is better or worse than that set of data usually does in that network NET.X; i.e., is that network NET.X better off without the node(s) N.X that were removed, for whatever value of ‘better off’ is aimed for? If so, in step 21.10, the network modification may be made permanent; if not, in step 21.12, the network NET.X may be reverted to its previous state.

It is noted that, while perhaps not the only method for producing optimal networks N.X, this method is simple and automatable, and might prune away a lot of redundancy.

The method to thin out a network might be based on experimental data, such as keeping track of which nodes N.X or sections of the network NET.X are used the most while running, and thinning out nodes N.X or sections of the network NET.X which are never (or rarely) used later. The method to thin nodes N.X or sections of the network NET.X may be based on the results of many tests and measurements of a generated transition table network NET.X. The network NET.X may also be systematically pruned to, not just produce a same result or field of result using fewer nodes, but to select for producing a more preferred result or field of results. Rules that are correlated with better results have a much higher probability of surviving, and other rules that are not correlated with better results are more often selected for deletion.

A method to reduce the number of rules might be to select rules randomly for deletion, which has shown in test runs to have an increased performance of 59% (instead of a 50/50% random chance measurement). This “greater than 50%” result may be due to more efficient transition table networks that are able to run much faster than transition table networks that haven't had their transition tables reduced in size. In any case, utilizing two or more passes of a genetic algorithm has been shown to help improve the performance of transition table network functionality.

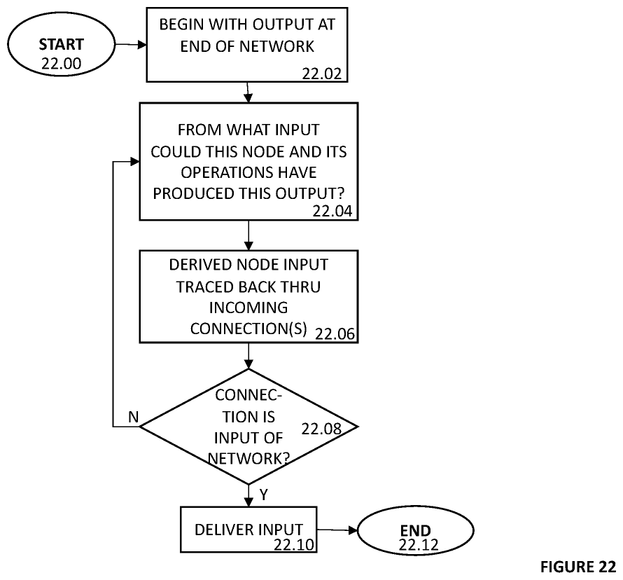

Referring now generally to the Figures and particularly to FIG. 22, FIG. 22 is a process chart for deriving or back-tracing a probable input value or values of a network such as the network of FIG. 6 from a known output value, through back propagation instead of the forward propagation of FIG. 10. It is recognized that, in many contexts, this kind of backwards analysis might not be possible, or might produce too many possible antecedents to be very useful, but the method for doing so is provided for application in contexts where relevant. It is further noted that this process chart may be considered as ‘on the same level’ of the nesting scheme of FIGS. 10-16 as FIG. 10, and essentially constitutes performing the process of FIG. 10 backwards. In step 22.00 the process starts. In step 22.02, the starting value is the output of the network, and the first node to begin with is the last node of the network. In step 22.04, the node operations of the current node are reversed; given the present signal value, which operations of the current node would have produced that signal value, and from what previous input? In step 22.06, the derived input is traced back through the current node's incoming connections, leading to one or more node(s) that input may have originated from. This continues until the input is traced back to the input of the network itself; step 22.08 checks whether the tracing process is there yet, and continues tracing if not. Once the input has been traced back to the input of the network, then this is the result, and is delivered at step 22.10. At step 22.12, the process ends.

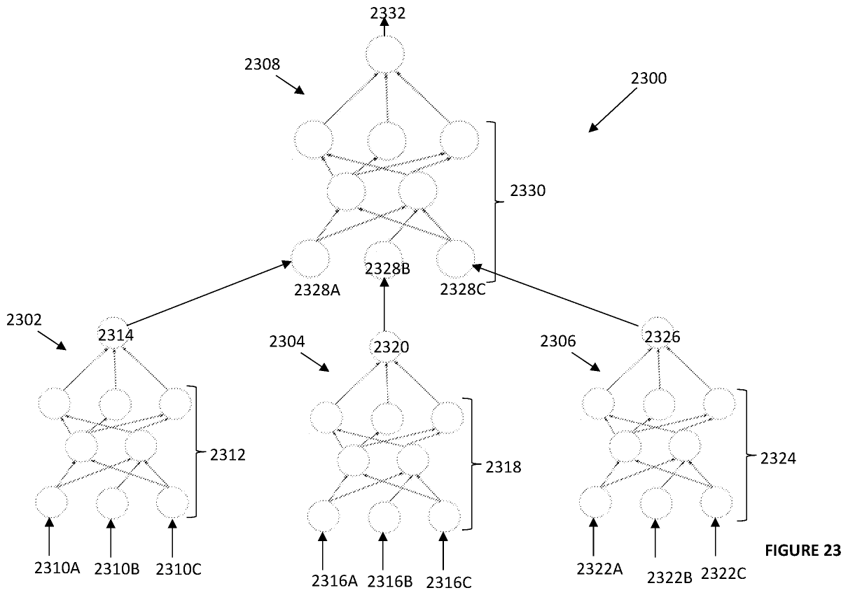

Referring now to the Figures and particularly to FIG. 23, FIG. 23 is a diagram presenting a plurality of networks NET.X connected together into a super network 2300. As presented here, multiple transitional table networks NET.X may further be networked together, such that the output of one network NET.X becomes an input of another. In this way, it becomes possible to construct, not just a single AI ‘brain area’ that performs a specified task or tasks, but an AI ‘brain’ that coordinates and operates based on the results of tasks from a plurality of such sections. This super network 2300 may be viewed either as four separate interconnected networks NET.X, or one network NET.X subdivided into four sections; this description will refer to these as a first subnetwork 2302, a second subnetwork 2304, a third subnetwork 2306, and a fourth subnetwork 2308, or collectively as the subnetworks 2302-2308. The first subnetwork 2302 may include a plurality of first subnetwork inputs 2310, namely a first subnetwork A input 2310A, a first subnetwork B input 2310B, and a first subnetwork C input 2310C; a plurality of first subnetwork nodes 2312, and a first subnetwork output 2314. The second subnetwork 2304 may include a plurality of second subnetwork inputs 2316, namely a second subnetwork A input 2316A, a second subnetwork B input 2316B, and a second subnetwork C input 2316C; a plurality of second subnetwork nodes 2318, and a second subnetwork output 2320. The third subnetwork 2306 may include a plurality of third subnetwork inputs 2322, namely a third subnetwork A input 2322A, a third subnetwork B input 2322B, and a third subnetwork C input 2322C; a plurality of third subnetwork nodes 2324, and a third subnetwork output 2326. The fourth subnetwork 2308 may include a plurality of fourth subnetwork inputs 2328, namely a fourth subnetwork A input 2328A, a fourth subnetwork B input 2328B, and a fourth subnetwork C input 2328C; a plurality of fourth subnetwork nodes 2330, and a third subnetwork output 2332.

Regarding this super network 2300, the most important concept to make clear is that any network NET.X in general may be small and stand alone in certain alternate preferred embodiments of the invented method, and in additional alternate preferred embodiments of the invented method the network NET.X optionally branches off into 1 or more different the transitional table network NET.X. This allows for building of entire ‘brains’, instead of just single ‘brain areas’. The branching would be implemented as a form of ‘pointer’ to another structure, which could be:
the originating node's output to a different TTN node's input;
the originating node's translation table row to a different node's input; or
the originating node's translation table row to a different node's translation table.

In the diagram of FIG. 23, the first subnetwork output 2314 is directed into the fourth subnetwork A input 2328A; this may be the output value produced by the operation of the first subnetwork 2302, or this may be the translation table T.X assembled by operations of the first subnetwork 2302. Further, if the translation table T.X is carried over, this may be as a translation table T.X for the fourth subnetwork 2308 also, or this may be as an input value itself. This simply means that inputs, outputs, or lines of a translation table can be either alphanumeric symbol string signals SI.X, or they can be pointers into various parts of another TTN.

Referring now generally to the Figures and particularly to FIGS. 24A through 24C, FIGS. 24A through 24C present an additional mechanism for networks to internally regulate their functionality, particularly as constituents of a larger network structure with a tendency to get shifted around, as in this presently described environment. This concept was described in the thesis document incorporated herein by reference and included as an attachment, and the Holland ECHO model, also incorporated herein by reference, described a similar mechanism. Each neural network node may or may not have ‘offense’ and ‘defense’ tags, whereby, if the offense tag (output) matches up to the defense tag (input) using this formula, the input is active.

Referring now generally to the Figures and particularly to FIG. 24A, FIG. 24A presents a first node 2400 and a second node 1402, which are instances of the node N.X as found in the network NET.X. Only two nodes N.X are included here as a simple example explaining this concept. The first node 2400 has a signal to pass on to the second node 2402, which reads “abc”. However, the second node 2402 has a defense tag “bb#”, and is filtering any possible inputs to match that defense tag. If the offense tag doesn't match the defense tag, or matches poorly, the input is turned off. A certain output value may be filtered or not necessarily be accepted by the connected input, or only under certain conditions such as the values of the other inputs. This might be understood as a ‘masking’ or ‘filter’ element, providing an additional layer that determines whether the node accepts a certain type of incoming signal at all, before interacting with or processing the contents. If one thinks of each network NET.X as a function in a computer code sense—i.e., a black box that accepts a certain type of input, does some operations, and returns a certain type of output—providing ‘checks’ at the start of a function verifying acceptable input, for whatever definition of acceptable, is a good practice for writing stable code, but can also be a powerful tool to influence the possible result of the operations done. When these networks get complex, it makes sense to have this kind of arbitration built into the objects, rather than managed globally (such as by carefully organizing the whole network NET.X so nodes only ever receive the signals they're supposed to), particularly in an environment where the networks NET.X are constantly being recombined and rearranged, such as in accordance with the present invented method. The process explicated here, with reference to the tables of FIGS. 24B and 24C, will show how it is determined whether the signal being sent by the first node 2400 is accepted or rejected by the second node 2402.

Referring now generally to the Figures and particularly to FIG. 24B, FIG. 24B is a ‘node combat’ table comparing the offense tag of the first node 2400 to the defense tag of the second node 2402 in the example begun in FIG. 24A.

If the offense tag (output) of a node matches up to the defense tag of another (input) node using this formula, the input is active. If the tags don't match, the input is turned off and/or the output reverts to the ‘default’ value. When an input enters a node, the offense tag of the input node is matched up against the defense tag of the current node. A ‘match score’ is computed based on a combat matrix such as the table of FIG. 24B. If the match score is high, the input agent “wins” and the input is accepted. However, if the match score is negative, the defending node will use the ‘default’ entry in the transition table instead. An example of a combat matrix (similar to Holland, 1995) is shown in the table of FIG. 24B. The combat matrix given in Table of FIG. 24B represents the “locus score” example given in Holland [1995]. Using the combat matrix of FIG. 24B, if the first node 2400 with the offense tag ‘abc’ encounters the second node 1402 with the defense tag ‘bb#’, the match score is added up as illustrated in the equation of FIG. 24C.

Referring now generally to the Figures and particularly to FIG. 14C, FIG. 14C is an equation ‘showing the work’ of comparing the first node 2400 with the offense tag ‘abc’ to the second node 2402 with the defense tag ‘bb#’ and determining whether the interaction is permitted.

Interaction is achieved only if a match score is achieved that allows the interaction to occur. The score is calculated by matching the incoming tag of node with the defense tag of the node it is interacting with. If the Defense match score is high enough (an adjustable parameter), the two nodes interact and the transition table is executed.

In this instance, three comparisons took place:
The first symbol of the offense tag was ‘a’ and the first symbol of the defense tag was ‘b’, so according to the table of FIG. 24B, the score value of this comparison is −2.
The second symbol of the offense tag was ‘b’ and the second symbol of the defense tag was ‘b’, so according to the table of FIG. 24B, the score value of this comparison is 2.
The third symbol of the offense tag was ‘c’ and the first symbol of the defense tag was ‘#’, so according to the table of FIG. 24B, the score value of this comparison is −1.

These scores are summed together to determine a match score of −1, as shown. Depending on the threshold this may or may not be enough for the nodes to interact, but one can appreciate that this scoring system allows a quantitative assessment of node compatibility, providing gates against unexpected input that might otherwise cause undefined behavior.

This example pertained to just two nodes N.X assigned arbitrary values for demonstration, but any node or plurality of nodes N.X might include these features and follow these methods and signal SI.X values may differ vastly from the simple examples presented herein.

Referring now generally to the Figures and particularly to FIGS. 25A & 25B, FIGS. 25A & 25B are a diagram and table explicating the concept of Shadow Tables, which are additional functions built into the same node for controlling different aspects besides the output signal. For instance, a shadow table may control which of multiple possible paths to other nodes are available as a next step, depending on what the signal output is, or cause an interface feature to be presented differently, such as color-coding.

Referring now generally to the Figures and particularly to FIG. 25A, FIG. 25A is a diagram presenting a node 2500 (which is an instance of the node N.X), having an INPUT and four possible output directions, LEFT, RIGHT, STRAIGHT, and POINTER TO OTHER NETWORK, leading to other nodes N.X or networks NET.X not shown.

Referring now generally to the Figures and particularly to FIG. 25B, FIG. 25B is a shadow table 2502 associated with the node 2500. Depending on the input received by the node 2500 and the work done by the transition table T.X of the node 2500, the signal output direction might change based on the shadow table, in this case ‘sorting’ the signals directionally into those containing a's, b's, both, or neither. The signals may contain other symbols, such as p's or q's, but this shadow table of FIG. 25B doesn't care about them.

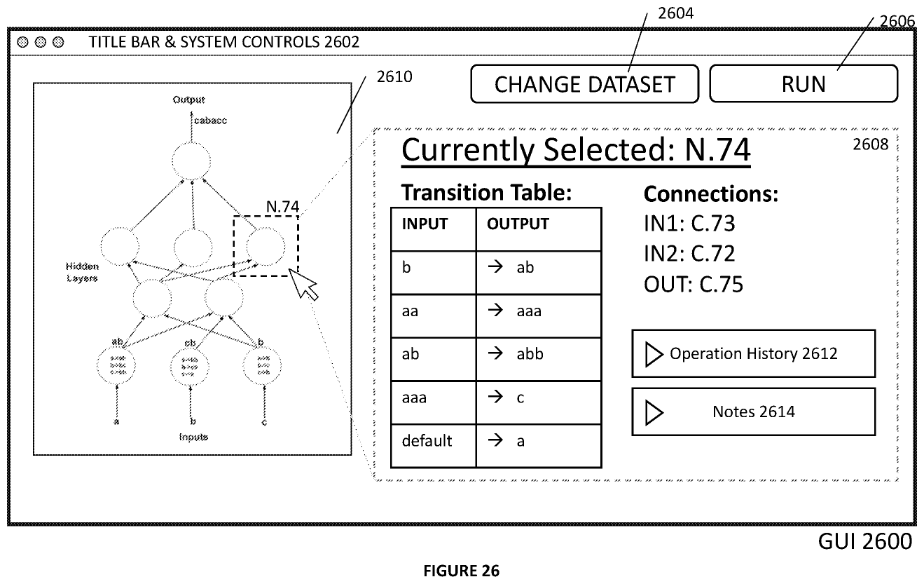

Referring now generally to the Figures, and particularly to FIG. 26, FIG. 26 is a diagram presenting an invented graphical user interface (GUI) that may be utilized for practicing the invention. Included here are a title bar and standard close/minimize/maximize buttons (Mac OSX style, in this case, though that shouldn't be construed as a limitation in OS compatibility). Further additional ‘standard’ software program controls may be included as appropriate, such as ‘save’, ‘load’, ‘print’, ‘export’, ‘quit’, ‘cut’, ‘copy’, ‘paste’, and so on; these are not drawn, and the title bar is considered as a sort of representative indicator of these standard and expected software elements; these days, only retro software written prior to about 1995 has a chance of not including expected elements like ‘print’ and ‘quit’. The graphical user interface provided may include some or all of the elements as shown, including a “Change Dataset” button 2604 for modifying which dataset is being used as network input, a “Run” button 2606 for running the current network(s) using the current dataset, an some features for analyzing and querying elements of a network, such as the presented summary 2608 of a selected node N.74, including that node's position within the network map 2610 presented at left, the node's connections (two inputs, C.73 and C.72, and an output, C.75), transition table TT.74, (recent) operation history 2612, and any other content regarding that node, such as developer notes 2614. It is noted that any or all of these elements might be included in the node record 700 of FIG. 7A. It is understood that the presented graphical user interface does not constitute an exhaustive depiction of every element that might be usefully included in a GUI about the present invention, and is intended only as a conceptual demonstration of some elements which might be.

More sophisticated schemes for controlling which nodes provide output to other inputs where and when are easily conceived of, and the art of building just about any kind of network, physical or digital, practices high levels of complication with this. In particular, one aspect of complication that may be suitably implemented in this kind of network is modeled after the biological phenomenon of “wire together, fire together”, whereby nodes in proximate positions to one another will sometimes influence each other's output, such that if there are three neurons close together and two of them are controlled to fire and the third one isn't, the third may still fire, at least a little, because the other two did. There are various schemes to determine whether the wire-fire-together nodes will fire. The output of such nearby nodes may operate by the ‘default’ value of the translation table.

In the spirit of biology's “wire together, fire together”, if nearby neighbor nodes fire, there is a probability that a node will produce some output. There are various schemes to determine whether the wire-fire-together nodes will fire, but the nodes with the most influence are likely to be the nodes that are immediately adjacent.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

We claim:

1. In a graph database comprising a plurality of nodes and edges, each edge connecting two nodes, a method for altering an output symbol string of a node, the method comprising:
Programming a first selected node to perform a node operation upon a received input symbol string;
Associating a first transition table with the first selected node, the first transition table including a plurality of pairs of string segments and string operations (hereinafter, “plurality of pairs”);
Reception of a first input symbol string, wherein the first input symbol string includes at least one non-numeric symbol;
Comparing a first string segment of the first transition table with the first input symbol string;
When a match between the first string element of the first transition table and a portion or all of the first input symbol string is detected, selecting a first string operation that is paired with the first string element within the plurality of pairs;
Deriving a resultant output string at least partially on the basis of an application of the first string operation in response to matching the at least one string element to a portion or all of the first input symbol string; and
Communicating the resultant output string from the first selected node to a second node of the graph database.

2. The method of claim 1, wherein the applying the first string operation comprises selecting at least a portion of the first input symbol string as an operand and applying a symbol processing operation to the selected operand and therefrom generating a result, whereby the resultant output string is at least partially derived from the result.

3. The method of claim 1, wherein the applying the first string operation comprises selecting at least a portion of the first input symbol string as an operand and applying a mathematical operation to the selected operand and therefrom generating a result, whereby the resultant output string includes the result.

4. The method of claim 1, wherein the first string operation comprises replacing a selection or all of the first input symbol string with a first alternate symbol string in a generation of the resultant output string, whereby the first alternate symbol string is included in the resultant output string.

5. The method of claim 1, wherein the first string operation comprises generating a concatenated symbol string by concatenating a selection or all of the first input symbol string with a second alternate symbol string in a generation of the resultant output string, whereby the concatenated symbol string is included in the resultant output string.

6. The method of claim 1, wherein the node operation generates a resultant output string that comprises the first input symbol string.

7. The method of claim 1, wherein the node operation is not applied in deriving the resultant output string when a match is found between the first input symbol string and the first string segment.

8. The method of claim 1, wherein the node operation is applied in deriving the resultant output string when a match is found between the first input symbol string and the first string segment in addition to the application of a first string operation to the first input symbol string.

9. The method of claim 1, further comprising:
Comparing an additional string segment of the first transition table with the first input symbol string;
When a match between the additional string element of the first transition table and a portion or all of the first input symbol string is detected, selecting an additional string operation that is paired with the additional string element within the plurality of pairs;
Deriving a resultant output string at least partially on the basis of an application of the additional string operation in response to matching additional string element to a portion or all of the first input symbol string.

10. The method of claim 9, wherein applying the additional string operation comprises selecting at least a portion of the first input symbol string as an operand and applying an additional mathematical operation to the selected operand and therefrom generating a result, whereby the resultant output string is at least partially derived from the result.

11. The method of claim 9, wherein the applying the second string operation comprises selecting at least a portion of the first input symbol string as an operand and applying a second mathematical operation to the selected operand and therefrom generating a result, whereby the resultant output string includes the result.

12. The method of claim 9, further comprising:
Comparing a plurality of string segments of the first transition table with the first input symbol string;
When a match between the any string element of the first transition table and a portion or all of the first input symbol string is detected, selecting each associated string operation that is paired with any matching string element within the plurality of pairs;
Deriving a resultant output string at least partially on the basis of an application of the associated operations in response to matching the at least one string element of the plurality of pairs to one or more portions or all of the first input symbol string.

13. A database management system, comprising:
a processor; and
a memory communicatively coupled with the processor and storing a graph database management system adapted to update a first graph database, the first comprising a plurality of nodes connected by edges, and the memory further storing executable instructions that, when executed by the processor, perform operations comprising:
Programming a first selected node of the first graph database to perform a node operation upon a received input symbol string;
Associating a first transition table with the first selected node, the first transition table including a plurality of pairs of string segments and string operations (hereinafter, “plurality of pairs”);
Reception of a first input symbol string, wherein the first input symbol string includes at least one non-alphanumeric symbol;
Comparing a first string segment of the first transition table with the first input symbol string;
When a match between the first string element of the first transition table and a portion or all of the first input symbol string is detected, selecting a first string operation that is paired with the first string element within the plurality of pairs;
Deriving a resultant output string at least partially on the basis of an application of the first string operation in response to matching the at least one string element to a portion or all of the first input symbol string; and
Communicating the resultant output string from the first selected node to a second node of the first graph database, such that the output string of the first selected node becomes an input string of the second node.

14. The database management system of claim 13, the memory comprising additional executable instructions that, when executed by the processor, perform operations comprising:
applying the first string operation comprising selecting at least a portion of the first input symbol string as an operand and applying a mathematical operation to the selected operand and therefrom generating a result, whereby the resultant output string is at least partially derived from the result.

15. The database management system of claim 14, the memory comprising additional executable instructions that, when executed by the processor, perform operations comprising:
executing the first string operation to select at least a portion of the first input symbol string as an operand and applying a mathematical operation to the selected operand and therefrom generating a result, whereby the resultant output string includes the result.

16. The database management system of claim 14, the memory comprising additional executable instructions that, when executed by the processor, perform operations comprising:
Executing the first string operation to replace a selection or all of the first input symbol string with a first alternate symbol string in a generation of the resultant output string, whereby the first alternate symbol string is included in the resultant output string.

17. The database management system of claim 14, the memory comprising additional executable instructions that, when executed by the processor, perform operations comprising:
executing the first string operation to generate a concatenated symbol string by concatenating a selection or all of the first input symbol string with a second alternate symbol string in a generation of the resultant output string, whereby the concatenated symbol string is included in the resultant output string.

18. The database management system of claim 14, the memory comprising additional executable instructions that, when executed by the processor, perform operations comprising:
generating a resultant output string that comprises the first input symbol string.

19. The database management system of claim 14, the memory comprising additional executable instructions that, when executed by the processor, perform operations comprising:
deriving the resultant output string when a match is found between the first input symbol string and the first string segment without application of the node operation.
